(19) United States
(12) Patent Application Publication
(10) Pub. No.: US 2017/0034496 A1
(43) Pub. Date: Feb. 2, 2017

(54) ENDOSCOPE SYSTEM AND METHOD OF OPERATING ENDOSCOPE SYSTEM

(71) Applicant: FUJIFILM Corporation, Tokyo (JP)

(72) Inventors: Yoshiaki ISHIMARU, Ashigarakami-gun (JP); Masahiro KUBO, Ashigarakami-gun (JP)

(73) Assignee: FUJIFILM Corporation, Tokyo (JP)

(21) Appl. No.: 15/218,265

(22) Filed: Jul. 25, 2016

(30) Foreign Application Priority Data
Jul. 31, 2015 (JP) 2015-152226

(51) Int. Cl. H04N 9/81; G06T 5/50; H04N 9/64; H04N 5/225; H04N 9/04

(52) U.S. Cl. CPC H04N 9/81; H04N 5/2256; H04N 9/045; H04N 9/646; G06T 5/50; H04N 2005/2255; G06T 2207/20224

(57) ABSTRACT

A light source including LEDs for emitting violet, blue, green and red light is controlled, to change over a first emission mode for emitting light of all the four colors for broadband illumination, and a second emission mode for emitting green light for correction. A color image sensor having blue, green and red pixels is controlled, and outputs B1, G1 and R1 image signals by imaging in the first emission mode, and B2, G2 and R2 image signals by imaging in the second emission mode. The B2 image signal of the blue pixels in the second emission mode is subtracted from the B1 image signal of the blue pixels in the first emission mode. A high quality image is generated according to the B1 image signal after the subtraction. Thus, occurrence of poor quality of color rendering can be prevented.

### CROSS-REFERENCE TO RELATED APPLICATION

This application claims priority under 35 USC 119 from Japanese Patent Application No. 2015-152226, filed 31 Jul. 2015, the disclosure of which is incorporated by reference herein.

### BACKGROUND OF THE INVENTION

1. Field of the Invention

The present invention relates to an endoscope system and a method of operating the endoscope system. More particularly, the present invention relates to an endoscope system in which light of a broadband of a wavelength is used for illuminating an object of interest, and in which occurrence of poor color rendering can be prevented even in the use of this light, and a method of operating the endoscope system.

2. Description Related to the Prior Art

An endoscope system is well-known and widely used in medical diagnosis. The endoscope system includes a light source apparatus, an electronic endoscope and a processing apparatus. The light source apparatus generates light for illuminating an object of interest. The endoscope includes an image sensor, and outputs an image signal by imaging the object of interest illuminated with the light. The processing apparatus produces a diagnostic image by image processing of the image signal, and drives a monitor display panel to display the image.

Known examples of the light source apparatus include an apparatus having a white light source such as a xenon lamp, white LED (light emitting diode) or the like as disclosed in JP-A 2014-050458, and an apparatus having a white light source constituted by a laser diode (LD) and phosphor for emitting fluorescence of excitation upon receiving the light from the laser diode, as disclosed in U.S. Pat. No. 9,044,163 (corresponding to JP-A 2012-125501). Also, a semiconductor light source is suggested in U.S. Pat. No. 7,960,683 (corresponding to WO 2008-105370), and includes blue, green and red LEDs for emitting blue, green and red light, so that light of the plural colors can be combined for preferences by discretely controlling the LEDs. There is an advantage in the semiconductor light source with high degree of freedom in outputting light of desired color balance (hue) by discretely controlling intensities of the light of the colors in comparison with the white light source.

For some reasons of the structure, pixels of a color image sensor for use in the endoscope are sensitive to light of a predetermined relevant color and also to light of a color other than the predetermined color. The above-described light source for illuminating the object of interest emits light of a broadband, such as white light, combined light of plural colors and the like, for example, a xenon lamp. In combination with such a light source, color mixture may occur with the color image sensor, because returned light of light of plural colors is received by the pixels of the relevant color. There occurs a problem of a poor quality in color rendering in the color mixture.

To solve this problem, U.S. Pat. No. 7,960,683 (corresponding to WO 2008-105370) discloses a method of previously obtaining a correction coefficient for correcting color rendering by use of a color chart before endoscopic imaging, and performing color correction according the correction coefficient during the endoscopic imaging. However, a characteristic of reflection of light at an object of interest is different between body parts, such as an esophagus, stomach, large intestine and the like. Color mixture at the pixels of the color image sensor is changeable between the body parts. It is difficult to prevent occurrence of a poor quality of the color rendering of imaging in the use of the color correction according to U.S. Pat. No. 7,960,683 (corresponding to WO 2008-105370).

### SUMMARY OF THE INVENTION

In view of the foregoing problems, an object of the present invention is to provide an endoscope system in which light of a broadband of a wavelength is used for illuminating an object of interest, and in which occurrence of poor color rendering can be prevented even in the use of this light, and a method of operating the endoscope system.

In order to achieve the above and other objects and advantages of this invention, an endoscope system includes a light source controller for controlling changeover between first and second emission modes, the first emission mode being for emitting light of at least two colors among plural colors of light emitted discretely by a light source, the second emission mode being for emitting partial light included in the light emitted in the first emission mode. A color image sensor has pixels of the plural colors, the pixels including particular pixels sensitive to a light component included in the light emitted in the first emission mode but different from the partial light emitted in the second emission mode, the particular pixels being also sensitive to the partial light emitted in the second emission mode. An imaging controller controls the color image sensor to image an object illuminated in the first emission mode to output first image signals, and controls the color image sensor to image the object illuminated in the second emission mode to output second image signals. A subtractor performs subtraction of an image signal output by the particular pixels among the second image signals from an image signal output by the particular pixels among the first image signals. An image processor generates a specific image according to the first image signals after the subtraction.

Preferably, the light source controller sets emission time of emitting the light in the second emission mode shorter than emission time of emitting the light in the first emission mode.

Preferably, the subtractor performs the subtraction for each of the pixels.

In another preferred embodiment, the subtractor performs the subtraction for a respective area containing plural pixels among the pixels.

Preferably, the imaging controller performs imaging of the object illuminated in the first emission mode at a first imaging time point, and performs imaging of the object illuminated in the second emission mode at a second imaging time point different from the first imaging time point. The subtractor performs the subtraction so that the image signal output by the particular pixels among the second image signals output by imaging at the second imaging time point is subtracted from the image signal output by the particular pixels among the first image signals output by imaging at the first imaging time point being earlier than the second imaging time point.

In one preferred embodiment, the imaging controller performs imaging of the object illuminated in the first emission mode at a first imaging time point, and performs imaging of the object illuminated in the second emission mode at a second imaging time point different from the first imaging time point. The subtractor performs the subtraction so that the image signal output by the particular pixels among the second image signals output by imaging at the second imaging time point is subtracted from the image signal output by the particular pixels among the first image signals output by imaging at the first imaging time point being later than the second imaging time point.

Preferably, furthermore, a signal amplifier amplifies the image signal output by the particular pixels among the second image signals.

Preferably, the signal amplifier averages an image signal output from an area containing plural pixels among the pixels, to perform the amplification for respectively the area.

Preferably, furthermore, a storage medium stores the second image signals. The subtractor performs the subtraction by use of the image signal output by the particular pixels among the second image signals stored in the storage medium.

Preferably, the light source controller further performs a control of repeating the first emission mode in addition to a control of changing over the first and second emission modes. The light source controller periodically performs the control of changing over and the control of repeating the first emission mode.

Preferably, the light source includes a violet light source device for emitting violet light, a blue light source device for emitting blue light, a green light source device for emitting green light, and a red light source device for emitting red light. The particular pixels are at least one of blue pixels sensitive to the violet light and the blue light, red pixels sensitive to the red light, and green pixels sensitive to the green light.

Preferably, the light source controller in the first emission mode performs violet, blue, green and red light emission to emit the violet light, the blue light, the green light and the red light by controlling the violet, blue, green and red light source devices. The subtractor performs the subtraction so that the image signal output by the particular pixels among the second image signals output in the second emission mode is subtracted from the image signal output by the particular pixels among the first image signals output in the violet, blue, green and red light emission.

Preferably, the light source controller in the second emission mode performs violet, blue and red light emission to emit the violet light, the blue light and the red light by controlling the violet, blue and red light source devices, and performs green light emission to emit the green light by controlling the green light source device. The imaging controller in the second emission mode performs imaging of the object illuminated by the violet, blue and red light emission and imaging of the object illuminated by the green light emission. The subtractor performs the subtraction so that an image signal output by the blue pixels constituting the particular pixels among the second image signals output in the green light emission is subtracted from an image signal output by the blue pixels constituting the particular pixels among the first image signals output in the violet, blue, green and red light emission. The subtractor performs the subtraction so that an image signal output by the green pixels constituting the particular pixels among the second image signals output in the violet, blue and red light emission is subtracted from an image signal output by the green pixels constituting the particular pixels among the first image signals output in the violet, blue, green and red light emission. The subtractor performs the subtraction so that an image signal output by the red pixels constituting the particular pixels among the second image signals output in the green light emission is subtracted from an image signal output by the red pixels constituting the particular pixels among the first image signals output in the violet, blue, green and red light emission.

In another preferred embodiment, the light source controller in the first emission mode performs blue and red light emission to emit the blue light and the red light by controlling the blue and red light source devices, and performs violet and green light emission to emit the violet light and the green light by controlling the violet and green light source devices, and the light source controller in the second emission mode performs green light emission to emit the green light by controlling the green light source device. The imaging controller in the first emission mode performs imaging of the object illuminated by the blue and red light emission and imaging of the object illuminated by the violet and green light emission, and the imaging controller in the second emission mode performs imaging of the object illuminated by the green light emission. The subtractor performs the subtraction so that an image signal output by the blue pixels constituting the particular pixels among the second image signals output in the green light emission is subtracted from an image signal output by the blue pixels constituting the particular pixels among the first image signals output in the violet and green light emission.

In a further preferred embodiment, the light source controller in the first emission mode performs violet, blue and red light emission to emit the violet light, the blue light and the red light by controlling the violet, blue and red light source devices, and performs green light emission to emit the green light by controlling the green light source device, and the light source controller in the second emission mode performs red light emission to emit the red light by controlling the red light source device. The imaging controller in the first emission mode performs imaging of the object illuminated by the violet, blue and red light emission and imaging of the object illuminated by the green light emission, and the imaging controller in the second emission mode performs imaging of the object illuminated by the red light emission. The subtractor performs the subtraction so that an image signal output by the blue pixels constituting the particular pixels among the second image signals output in the red light emission is subtracted from an image signal output by the blue pixels constituting the particular pixels among the first image signals output in the violet, blue and red light emission.

In another preferred embodiment, the light source controller in the first emission mode performs violet, blue and red light emission to emit the violet light, the blue light and the red light by controlling the violet, blue and red light source devices, and performs green light emission to emit the green light by controlling the green light source device, and the light source controller in the second emission mode performs violet and blue light emission to emit the violet light and the blue light by controlling the violet and blue light source devices. The imaging controller in the first emission mode performs imaging of the object illuminated by the violet, blue and red light emission and imaging of the object illuminated by the green light emission, and the imaging controller in the second emission mode performs imaging of the object illuminated by the violet and blue light emission. The subtractor performs the subtraction so that an image signal output by the red pixels constituting the particular pixels among the second image signals output in the violet and blue light emission is subtracted from an image signal output by the red pixels constituting the particular pixels among the first image signals output in the violet, blue and red light emission.

Preferably, the light source controller in the second emission mode performs green light emission to emit the green light by controlling the green light source device. The imaging controller performs imaging of the object illuminated by the green light emission. The image processor generates a green light image having a wavelength component of the green light according to an image signal output by the green pixels constituting the particular pixels among the second image signals output in the green light emission.

In still another preferred embodiment, the light source controller in the second emission mode performs green light emission to emit the green light by controlling the green light source device. The imaging controller performs imaging of the object illuminated by the green light emission. The image processor generates a normal image having a wavelength component of visible light according to an image signal output by the green pixels among the second image signals output in the green light emission, and a blue image signal output by the blue pixels, and an red image signal output by the red pixels, the blue and red image signals being among image signals output by imaging before or after imaging in the green light emission.

Also, a method of operating an endoscope system includes a step of controlling changeover in a light source controller between first and second emission modes, the first emission mode being for emitting light of at least two colors among plural colors of light emitted discretely by a light source, the second emission mode being for emitting partial light included in the light emitted in the first emission mode. There is a step of using an imaging controller for controlling a color image sensor to image an object illuminated in the first emission mode to output first image signals, and for controlling the color image sensor to image the object illuminated in the second emission mode to output second image signals, wherein the color image sensor has pixels of the plural colors, the pixels including particular pixels sensitive to a light component included in the light emitted in the first emission mode but different from the partial light emitted in the second emission mode, the particular pixels being also sensitive to the partial light emitted in the second emission mode. There is a step of performing subtraction of an image signal output by the particular pixels among the second image signals from an image signal output by the particular pixels among the first image signals in a subtractor. A specific image is generated according to the first image signals after the subtraction in an image processor.

Consequently, occurrence of poor color rendering can be prevented even in the use of this light, because a correction value obtained by use of the particular is utilized and subtracted from the image signal for imaging of an object of interest, to correct the color rendering suitably.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating an endoscope system;

FIG. 2 is a block diagram schematically illustrating the endoscope system;

FIG. 3A is a graph illustrating spectral distribution of light in a first emission mode;

FIG. 3B is a graph illustrating spectral distribution of light in a second emission mode;

FIG. 4 is a timing chart illustrating emission times of the first and second emission modes;

FIG. 5 is an explanatory view illustrating a color image sensor;

FIG. 6 is a graph illustrating a characteristic of transmission of color filters;

FIG. 7 is a table illustrating colors of light, their combinations and image signals in light emission;

FIG. 8 is a timing chart illustrating first and second imaging time points;

FIG. 9 is a block diagram schematically illustrating a digital signal processor;

FIG. 10 is a data chart illustrating the subtraction of the image signals;

FIG. 11 is a flow chart illustrating operation of the endoscope system;

FIG. 12A is a graph illustrating spectral distribution of light in the first emission mode in a second preferred embodiment;

FIGS. 12B and 12C are graphs illustrating spectral distribution of light in the second emission mode;

FIG. 13 is a table illustrating colors of light, their combinations and image signals in light emission;

FIG. 14 is a data chart illustrating the subtraction of the image signals;

FIGS. 15A and 15B are graphs illustrating spectral distribution of light in the first emission mode in a third preferred embodiment;

FIG. 15C is a graph illustrating spectral distribution of light in the second emission mode;

FIG. 16 is a table illustrating colors of light, their combinations and image signals in light emission;

FIG. 17 is a data chart illustrating an offset processor;

FIG. 18 is a graph illustrating a characteristic of transmission of color filters;

FIGS. 19A and 19B are graphs illustrating spectral distribution of light in the first emission mode in a fourth preferred embodiment;

FIG. 19C is a graph illustrating spectral distribution of light in the second emission mode;

FIG. 20 is a table illustrating colors of light, their combinations and image signals in light emission;

FIG. 21 is a data chart illustrating the subtraction of the image signals;

FIGS. 22A and 22B are graphs illustrating spectral distribution of light in the first emission mode in a fifth preferred embodiment;

FIG. 22C is a graph illustrating spectral distribution of light in the second emission mode;

FIG. 23 is a table illustrating colors of light, their combinations and image signals in light emission;

FIG. 24 is a data chart illustrating the subtraction of the image signals;

FIGS. 25A and 25B are graphs illustrating spectral distribution of light in the first emission mode in a sixth preferred embodiment;

FIGS. 25C, 25D, 25E and 25F are graphs illustrating spectral distribution of light in the second emission mode;

FIG. 26 is a table illustrating colors of light, their combinations and image signals in light emission;

FIG. 27 is a data chart illustrating the subtraction of the image signals;

FIGS. 28A and 28B are graphs illustrating spectral distribution of light in the first emission mode in a seventh preferred embodiment;

FIGS. 28C, 28D and 28E are graphs illustrating spectral distribution of light in the second emission mode;

FIG. 29 is a table illustrating colors of light, their combinations and image signals in light emission;

FIG. 30 is a data chart illustrating the subtraction of the image signals;

FIG. 31 is an explanatory view illustrating an embodiment of subtraction for a respective area containing plural pixels;

FIG. 32 is a timing chart illustrating an embodiment with first and second imaging time points;

FIG. 33 is a data chart illustrating a preferred offset processor having a signal amplifier;

FIG. 34 is a timing chart illustrating a preferred embodiment of a selectable structure of a control of changeover and a control of repetition of the first emission mode.

### DETAILED DESCRIPTION OF THE PREFERRED

### Embodiment(s) of the Present Invention

### First Embodiment

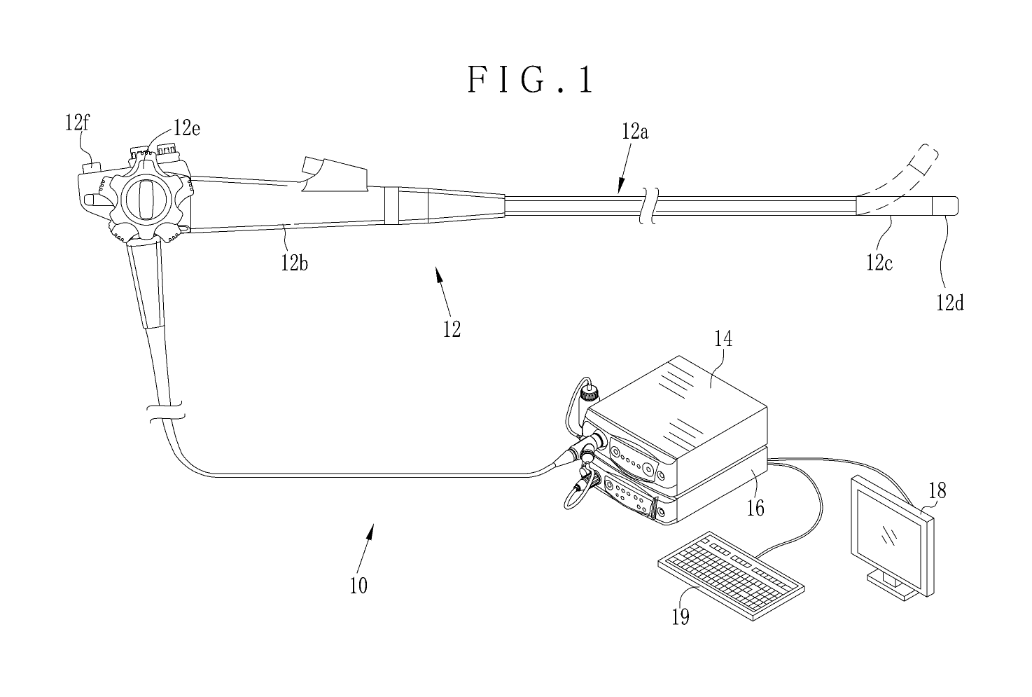

In FIG. 1, an endoscope system 10 includes an endoscope 12, a light source apparatus 14, a processing apparatus 16, a monitor display panel 18 and a user terminal apparatus 19 or console apparatus. The endoscope 12 is coupled to the light source apparatus 14 optically and connected to the processing apparatus 16 electrically. The endoscope 12 includes an elongated tube 12a or insertion tube, a grip handle 12b, a steering device 12c and an endoscope tip 12d. The elongated tube 12a is entered in a body cavity of a patient body, for example, gastrointestinal tract. The grip handle 12b is disposed at a proximal end of the elongated tube 12a. The steering device 12c and the endoscope tip 12d are disposed at a distal end of the elongated tube 12a. Steering wheels 12e are disposed with the grip handle 12b, and operable for steering the steering device 12c. The endoscope tip 12d is directed in a desired direction by steering of the steering device 12c.

In addition to the steering wheels 12e, a mode selector 12f is disposed with the grip handle 12b for changing over the imaging modes. The imaging modes include a normal imaging mode and a high quality imaging mode. In the normal mode, the monitor display panel 18 is caused to display a normal image in which an object is imaged with natural color balance with illumination of white light. In the high quality imaging mode, the monitor display panel 18 is caused to display a high quality image (specific image) with a higher image quality than the normal image.

The processing apparatus 16 is connected to the monitor display panel 18 and the user terminal apparatus 19 or console apparatus electrically. The monitor display panel 18 displays an image of an object of interest, and meta information associated with the image of the object. The user terminal apparatus 19 or console apparatus is a user interface for receiving an input action of manual operation, for example, conditions of functions. Also, an external storage medium (not shown) can be combined with the processing apparatus 16 for storing images, meta information and the like.

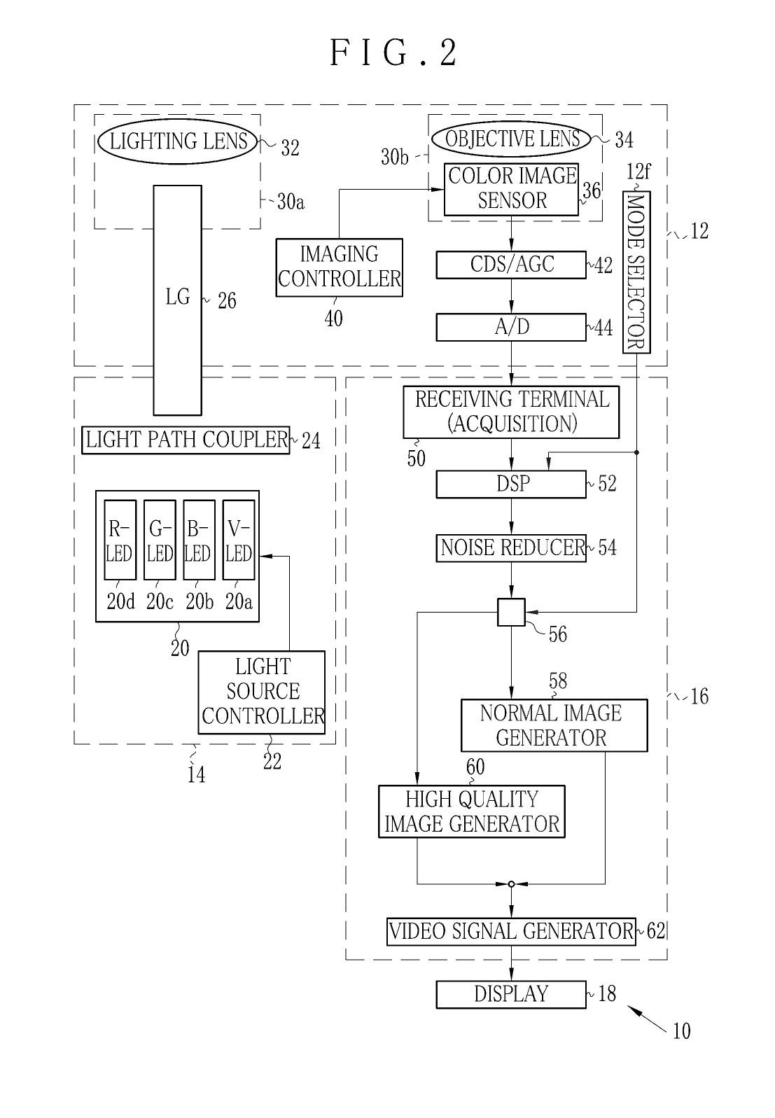

In FIG. 2, the light source apparatus 14 includes a light source 20, a light source controller 22 and a light path coupler 24.

The light source 20 includes plural semiconductor light source devices which are turned on and off. The light source devices include a violet LED 20a, a blue LED 20b, a green LED 20c and a red LED 20d (light-emitting diodes) of four colors.

The violet LED 20a is a violet light source device for emitting violet light V of a wavelength range of 380-420 nm. The blue LED 20b is a blue light source device for emitting blue light B of a wavelength range of 420-500 nm. The green LED 20c is a green light source device for emitting green light G of a wavelength range (wide range) of 500-600 nm. The red LED 20d is a red light source device for emitting red light R of a wavelength range of 600-650 nm. Note that a peak wavelength of each of the wavelength ranges of the color light can be equal to or different from a center wavelength of the wavelength range.

Light of the colors emitted by the LEDs 20a-20d is different in a penetration depth in a depth direction under a surface of mucosa of the tissue as an object of interest. Violet light V reaches top surface blood vessels of which a penetration depth from the surface of the mucosa is extremely small. Blue light B reaches surface blood vessels with a larger penetration depth than the top surface blood vessels. Green light G reaches intermediate layer blood vessels with a larger penetration depth than the surface blood vessels. Red light R reaches deep blood vessels with a larger penetration depth than the intermediate layer blood vessels.

The light source controller 22 controls the LEDs 20a-20d discretely from one another by inputting respective controls signals to the LEDs 20a-20d. In the control of the light emission in the light source controller 22, various parameters are controlled for the respective imaging modes, inclusive of time points of turning on and off the LEDs 20a-20d, light intensity, emission time and spectral distribution of light. In the normal mode, the light source controller 22 simultaneously turns on the LEDs 20a-20d, to emit violet, blue, green and red light V, B, G and R simultaneously.

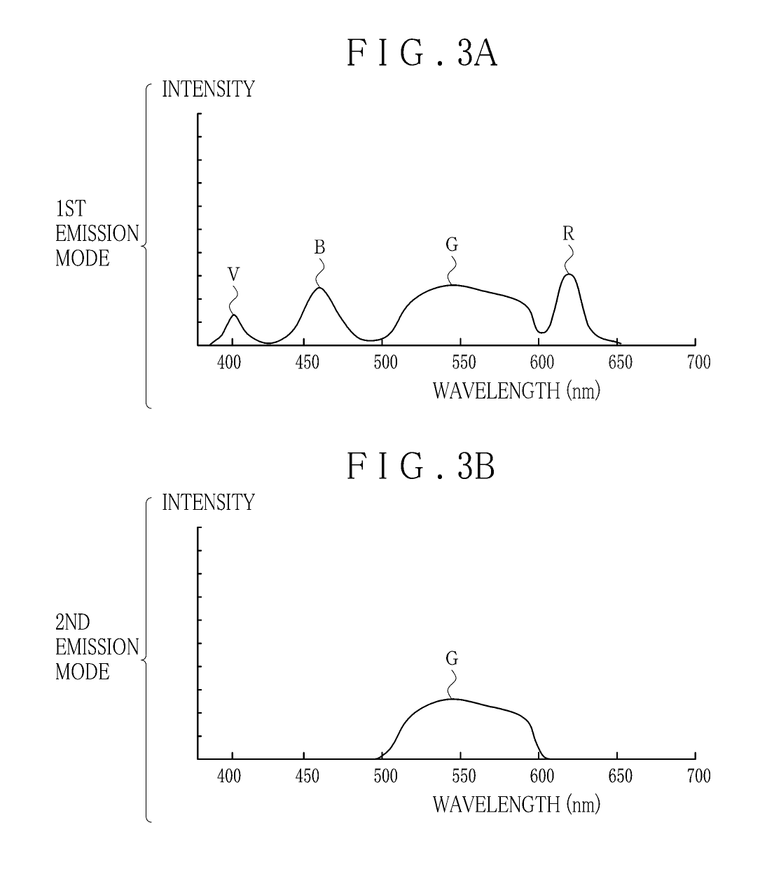

In the high quality imaging mode, the light source controller 22 in FIGS. 3A and 3B performs changeover between the first and second emission modes. In the embodiment, an imaging controller 40 to be described later is synchronized with the light source controller 22, which changes over the first and second emission modes.

In the first emission mode (for broadband illumination), the light source controller 22 emits light of at least two colors. In the embodiment, the light source controller 22 in FIG. 3A simultaneously turns on the LEDs 20a, 20b, 20c and 20d to perform the violet, blue, green and red light emission (VBGR) of emitting violet, blue, green and red light V, B, G and R of the four colors.

In the second emission mode (for correction), the light source controller 22 performs emission of partial light included in the light emitted in the first emission mode. The light source controller 22 in the present embodiment turns on the green LED 20c among the LEDs 20a-20d, and turns off the violet, blue and red LEDs 20a, 20b and 20d as illustrated in FIG. 3B. Green light emission is performed only to emit green light G.

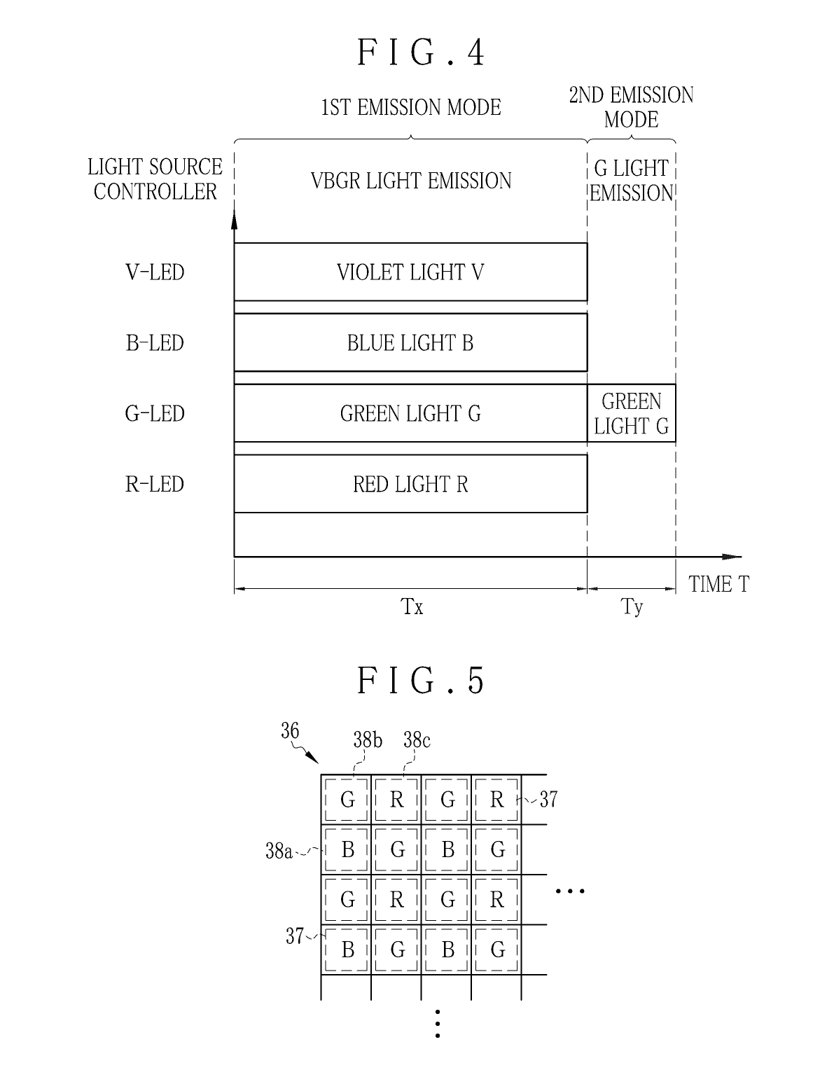

Also, the light source controller 22 sets emission time of emitting light in the first emission mode different from emission time of emitting light in the second emission mode. In FIG. 4, the light source controller 22 sets emission time Ty of emitting light in green light emission in the second emission mode shorter than emission time Tx of emitting light in violet, blue, green and red light emission (VBGR) in the first emission mode. For example, the emission time Ty is set ¼ as long as the emission time Tx. Note that the emission time Ty can be set ½ as long as the emission time Tx.

The light path coupler 24 is constituted by mirrors and lenses, and directs light from the LEDs 20a-20d to a light guide device 26. The light guide device 26 is contained in the endoscope 12 and a universal cable. The universal cable connects the endoscope 12 to the light source apparatus 14 and to the processing apparatus 16. The light guide device 26 transmits light from the light path coupler 24 to the endoscope tip 12d of the endoscope 12.

The endoscope tip 12d of the endoscope 12 includes a lighting lens system 30a and an imaging lens system 30b. A lighting lens 32 is provided in the lighting lens system 30a, and passes light from the light guide device 26 to application to an object of interest in the patient body. The imaging lens system 30b includes an objective lens 34 and a color image sensor 36. Returned light (image light) from the object of interest illuminated with the light is passed through the objective lens 34 and becomes incident upon the color image sensor 36. An image of the object is focused on the color image sensor 36.

The color image sensor 36 performs imaging of the object of interest illuminated with light, and outputs an image signal. Examples of the color image sensor 36 are a CCD image sensor (charge coupled device image sensor), CMOS image sensor (complementary metal oxide semiconductor image sensor), and the like.

In FIG. 5, a great number of pixels 37 are arranged on an imaging surface of the color image sensor 36 in a matrix form or plural arrays in a two-dimensional arrangement. Each one of the pixels 37 has one of a blue color filter 38a, a green color filter 38b and a red color filter 38c. Arrangement of the color filters 38a-38c is a Bayer format. The green color filter 38b is arranged in a pattern having one pixel arranged in two pixels. The blue color filter 38a and the red color filter 38c are arranged at remaining pixels in a square form.

Let blue pixels be the pixels 37 with the blue color filter 38a. The blue pixels correspond to particular pixels according to the present invention. Let green pixels be the pixels 37 with the green color filter 38b. Let red pixels be the pixels 37 with the red color filter 38c.

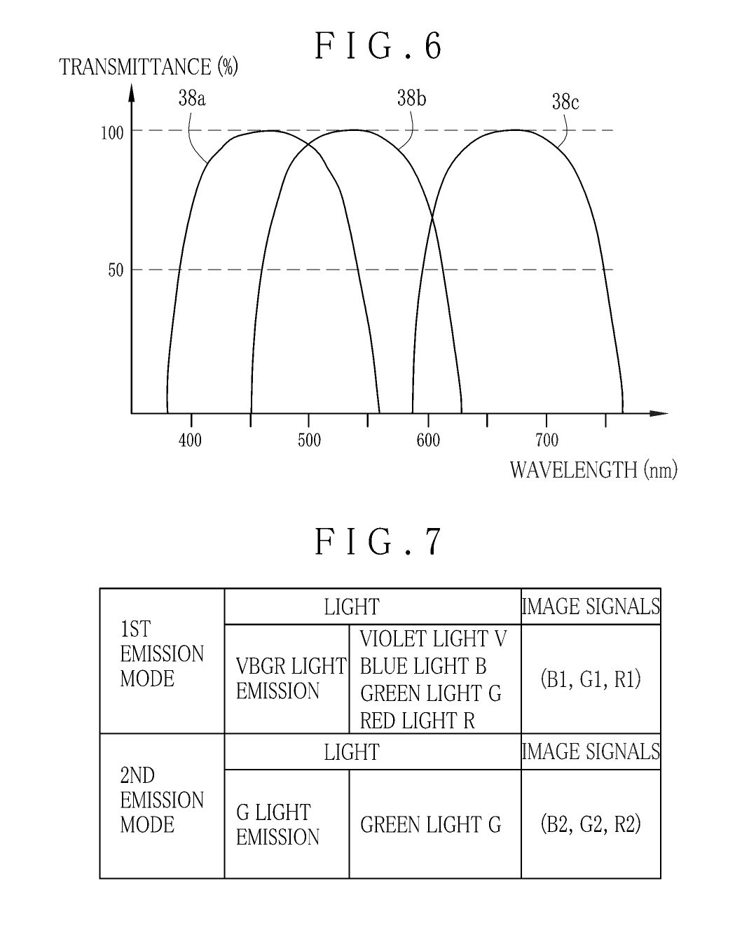

In FIG. 6, the blue color filter 38a passes light of a wavelength of 380-560 nm. The green color filter 38b passes light of a wavelength of 450-630 nm. The red color filter 38c passes light of a wavelength of 580-760 nm. The blue pixels are sensitive to the violet light V and blue light B, and receive returned light of the violet light V and blue light B. The green pixels are sensitive to the green light G, and receive returned light of the green light G. The red pixels are sensitive to the red light R, and receive returned light of the red light R. The returned light of the violet light V has information of top surface blood vessels located in a top surface of tissue. The returned light of the blue light B has information of surface blood vessels located in a surface of the tissue. The returned light of the green light G has information of intermediate layer blood vessels located in an intermediate layer of the tissue. The returned light of the red light R has information of deep layer blood vessels located in a deep layer of the tissue.

At the blue, green and red pixels, color mixture is likely to occur upon emission of light of plural colors simultaneously. Color mixture at the pixels is hereinafter described after simultaneously emitting violet, blue, green and red light V, B, G and R. Note that a simultaneous state according to the specification includes a state of completely the same time for the light of the plural colors, and also a state of nearly the same time with a small difference, and a state of the same period of one frame with a small difference of time points between the colors.

The blue pixels are sensitive not only to violet light V and blue light B but also to a light component of a short wavelength in green light G. Color mixture of the violet light V, the blue light B and the green light G occurs in the blue pixels because of receiving returned light of the violet light V, returned light of the blue light B, and returned light of the green light G.

The green pixels are sensitive to the green light G, and a long wavelength component included in the blue light B, and a short wavelength component included in the red light R. There occurs color mixture of green, blue and red light G, B and R at the green pixels by receiving returned light of the green light G, returned light of the blue light B, and also returned light of the red light R.

The red pixels are sensitive to the red light R and a long wavelength component included in the green light G. There occurs color mixture of red and green light R and G at the red pixels by receiving returned light of the red light R and also returned light of the green light G.

The characteristic of transmittance of the color filters 38a-38c described above is only an example. One image sensor may have red pixels additionally sensitive to blue light B, or blue pixels additionally sensitive to red light R.

The imaging controller 40 is electrically connected with the light source controller 22, and controls imaging of the color image sensor 36 in synchronism with control of the emission of the light source controller 22. In a normal mode, the imaging controller 40 performs imaging of one frame of an image of an object of interest illuminated with violet, blue, green and red light V, B, G and R. Thus, blue pixels in the color image sensor 36 output a blue image signal. Green pixels output a green image signal. Red pixels output a red image signal. The control of the imaging is repeatedly performed while the normal mode is set.

In the high quality imaging mode, control of imaging in the imaging controller 40 for the color image sensor 36 is different between the first and second emission modes, as illustrated in FIG. 7.

In the first emission mode, the imaging controller 40 performs imaging of one frame of an image of the object of interest illuminated with violet, blue, green and red light V, B, G and R. Thus, the blue pixels in the color image sensor 36 output a B1 image signal. The green pixels output a G1 image signal. The red pixels output an R1 image signal. The B1, G1 and R1 image signals generated in the first emission mode correspond to the first image signals in the present invention.

In the second emission mode, the imaging controller 40 performs imaging of one frame of an image of the object of interest illuminated with green light G. Thus, the blue pixels in the color image sensor 36 output a B2 image signal. The green pixels output a G2 image signal. The red pixels output an R2 image signal. The B2, G2 and R2 image signals generated in the second emission mode correspond to the second image signals in the present invention.

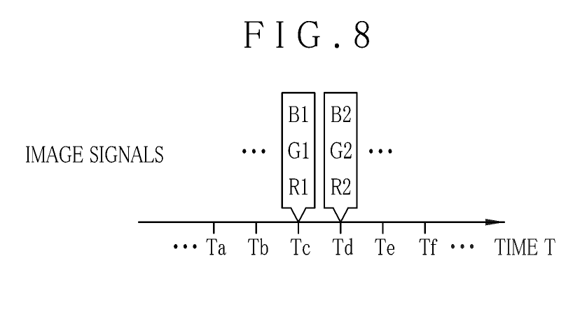

The imaging controller 40 performs imaging of the object of interest illuminated in the first emission mode at a first time point, and performs imaging of the object of interest illuminated in the second emission mode at a second time point which is different from the first time point. In FIG. 8, the imaging controller 40 selects the time Tc for the first time point and the time Td for the second time point among the times Ta-Tf. At the first time point, the B1, G1 and R1 image signals are output. At the second time point, the B2, G2 and R2 image signals are output.

In FIG. 2, a CDS/AGC device 42 or correlated double sampling/automatic gain control device performs correlated double sampling and automatic gain control of the image signal of the analog form obtained by the color image sensor 36. The image signal from the CDS/AGC device 42 is sent to an A/D converter 44. The A/D converter 44 converts the image signal of the analog form to an image signal of a digital form by A/D conversion. The image signal converted by the A/D converter 44 is transmitted to the processing apparatus 16.

The processing apparatus 16 includes a receiving terminal 50 or input terminal or image signal acquisition unit, a digital signal processor 52 or DSP, a noise reducer 54, a changeover unit 56 or signal distributor for image processing, a normal image generator 58, a high quality image generator 60 and a video signal generator 62. The receiving terminal 50 receives an image signal of a digital form from the endoscope 12, and inputs the image signal to the digital signal processor 52.

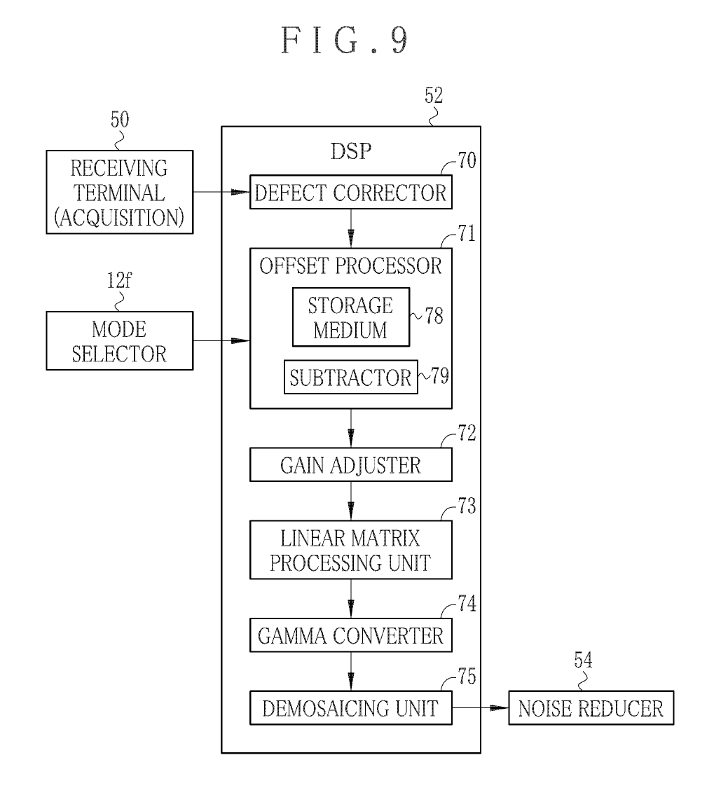

The digital signal processor 52 processes the image signal from the receiving terminal 50 in image processing of various functions. In FIG. 9, the digital signal processor 52 includes a defect corrector 70, an offset processor 71, a gain adjuster 72 or gain corrector, a linear matrix processing unit 73, a gamma converter 74 and a demosaicing unit 75.

The defect corrector 70 performs defect correction of an image signal from the receiving terminal 50. In the defect correction, the image signal output by a defective pixel in the color image sensor 36 is corrected.

The offset processor 71 processes the image signal in the offset processing after defect correction. The offset processor 71 performs the offset processing in methods different between the normal mode and the high quality imaging mode. In the normal mode, the offset processor 71 performs normal offset processing in which a component of a dark current is eliminated from the image signal after the defect correction, to set a zero level correctly for the image signal.

However, the offset processor 71 in the high quality imaging mode performs offset processing for high quality imaging, and prevents occurrence of a poor quality of color rendering of the object of interest even upon occurrence of color mixture, to obtain high quality for image quality of an image. The offset processing for high quality imaging will be described in detail. Note that it is possible to use the normal offset processing even in the high quality imaging mode.

The gain adjuster 72 performs the gain correction to an image signal after the offset processing. In the gain correction, the image signal is multiplied by a specific gain, to adjust a signal level of the image signal.

The linear matrix processing unit 73 performs linear matrix processing of the image signal after the gain correction. The linear matrix processing improves the color rendering of the image signal.

The gamma converter 74 processes the image signal in the gamma conversion after the linear matrix processing. In the gamma conversion, brightness and hue of the image signal are adjusted.

The demosaicing unit 75 processes the image signal after the gamma conversion for the demosaicing (namely, isotropization or synchronization). In the demosaicing, image signals of color with shortage in intensity are produced by use of interpolation. Thus, all of the pixels can have image signals of blue, green and red by use of the demosaicing. The image signal after the demosaicing is input to the noise reducer 54.

The noise reducer 54 processes the image signal for the noise reduction downstream of the demosaicing unit 75. In the noise reduction, noise in the image signal is reduced. Examples of methods of the noise reduction are a movement average method, median filter method and the like. The image signal after the noise reduction is transmitted to the changeover unit 56.

The changeover unit 56 changes over a recipient of the image signal from the noise reducer 54 according to a selected one of the imaging modes. In the normal mode, the changeover unit 56 sends the blue, green and red image signals to the normal image generator 58 after acquisition in the normal mode. In the high quality imaging mode, the changeover unit 56 sends the blue, green and red image signals to the high quality image generator 60 after acquisition in the high quality imaging mode.

The normal image generator 58 is used in case the normal mode is set. The normal image generator 58 generates a normal image according to the blue, green and red image signals from the changeover unit 56. The normal image generator 58 performs color conversion, color enhancement and structural enhancement to respectively the blue, green and red image signals. Examples of the color conversion are 3×3 matrix processing, gradation processing, three-dimensional lookup table (LUT) processing the like. The color enhancement is performed for the image signals after the color conversion. The structural enhancement is performed for the image signals after the color enhancement. An example of the structural enhancement is spatial frequency modulation. A normal image is formed according to the image signals after the structural enhancement. The normal image is transmitted to the video signal generator 62.

The high quality image generator 60 is used in case the high quality imaging mode is set. The high quality image generator 60 generates a high quality image according to the blue, green and red image signals from the changeover unit 56. The high quality image is transmitted to the video signal generator 62. Note that the high quality image generator 60 may operate to perform the color conversion, color enhancement and structural enhancement in the same manner as the normal image generator 58. The high quality image generator 60 corresponds to the image processor of the present invention.

The video signal generator 62 converts an input image into a video signal, which is output to the monitor display panel 18, the input image being either one of the normal image from the normal image generator 58 and the high quality image from the high quality image generator 60. Then the monitor display panel 18 displays the normal image in the normal mode, and the high quality image in the high quality imaging mode.

Offset processing for high quality imaging in the offset processor 71 for use in the high quality mode is hereinafter described. In FIG. 9, the offset processor 71 includes a storage medium 78 or memory, and a subtractor 79.

The storage medium 78 stores the B1, G1 and R1 image signals output in the first emission mode, and the B2, G2 and R2 image signals output in the second emission mode. For example, the storage medium 78 stores the B1, G1 and R1 image signals obtained at the time Tc or first imaging time point in the first emission mode, and stores the B2, G2 and R2 image signals obtained at the time Td or second imaging time point in the second emission mode. See FIG. 8. Note that only the B2, G2 and R2 image signals obtained in the second emission mode can be stored in the storage medium 78.

The subtractor 79 performs subtraction for the image signals output in the first emission mode by use of the image signals output in the second emission mode, among the image signals stored in the storage medium 78. Specifically, the subtractor 79 subtracts a second image signal output by particular pixels from a first image signal output by the particular pixels, the first image signal being one of the B1, G1 and R1 image signals output in the first imaging time point earlier than the second imaging time point, the second image signal being one of the B2, G2 and R2 image signals output in the second imaging time point. See FIG. 8. In the present embodiment, the particular pixels are blue pixels.

In FIG. 10, the subtractor 79 subtracts the B2 image signal output by the blue pixels from the B1 image signal output by the blue pixels, among the B1, G1 and R1 image signals and the B2, G2 and R2 image signals. In the first emission mode, color mixture occurs due to receiving returned light of violet and blue light V and B and partial returned light of green light G at the blue pixels. The B1 image signal leads to poor color rendering of imaging. In view of this, only green light G is emitted in the second emission mode, to obtain the B2 image signal by receiving partial returned light of the green light G at the blue pixels. The B2 image signal is subtracted from the B1 image signal, to obtain a B1 corrected image signal, with which the color rendering is corrected. The operation of the subtraction is performed for each of all of the pixels 37 in the color image sensor 36.

The B1 corrected image signal is input to the high quality image generator 60 after signal processing of the various functions and noise reduction, together with the G1 and R1 image signals. Thus, the high quality image formed by the high quality image generator 60 can be an image of high color rendering and higher quality than a normal image.

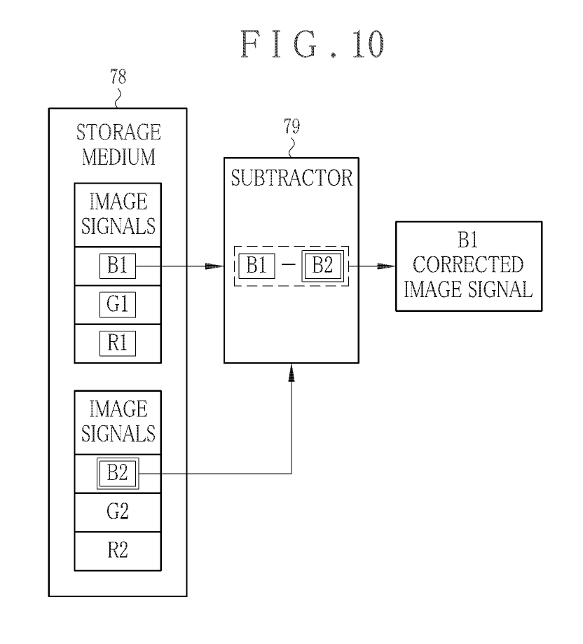

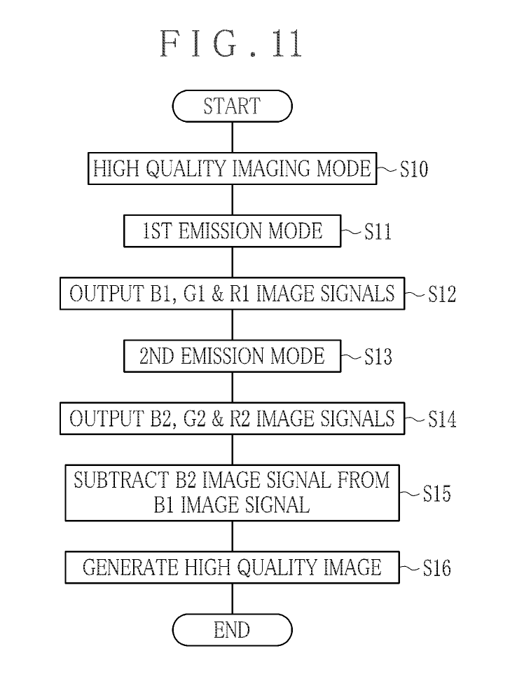

The operation of the embodiment is described by referring to FIG. 11. The mode selector 12f is manually operated to change over from the normal mode to the high quality imaging mode in a step S10. The light source controller 22 operates in the first emission mode in a step S11. The first emission mode performs violet, blue, green and red light emission (VBGR) to emit violet, blue, green and red light V, B, G and R simultaneously. In the first emission mode, the imaging controller 40 causes the color image sensor 36 to perform imaging of returned light of the colors from the object of interest, to output the B1, G1 and R1 image signals in a step S12.

Then the light source controller 22 changes over from the first emission mode to the second emission mode in a step S13. In the second emission mode, green light G is emitted in green light emission. The imaging controller 40 drives the color image sensor 36 to image returned light of the green light G from the object of interest in the second emission mode, to output the B2, G2 and R2 image signals in a step S14.

The subtractor 79 subtracts the B2 image signal output by the blue pixels from the B1 image signal output by the blue pixels, among the B1, G1 and R1 image signals in the first emission mode and the B2, G2 and R2 image signals in the second emission mode, in a step S15. The B1 and B2 image signals are signals output by the blue pixels which are particular pixels. The B1 image signal is an image signal obtained by the blue pixels receiving returned light of violet and blue light V and B and partial returned light of the green light G, and leads to poor color rendering of imaging. The B2 image signal is an image signal obtained by the blue pixels receiving partial returned light of the green light G. Thus, the subtraction of the image signals obtains the B1 corrected image signal, with which the color rendering is corrected. The high quality image generator 60 generates a high quality image according to the B1 corrected image signal, the G1 image signal and the R1 image signal in a step S16.

Consequently, occurrence of poor quality in the color rendering can be prevented reliably in the endoscope system 10 of the invention, because the B2 image signal output by the blue pixels in the second emission mode for emitting the green light G is subtracted from the B1 image signal output by the blue pixels in the first emission mode for simultaneously emitting the violet, blue, green and red light V, B, G and R in the high quality imaging mode. An image of high quality can be obtained with a correctly expressed form of the object of interest.

Also, the frame rate can be prevented from being lower even during the imaging in the second emission mode, because the emission time Ty for green light emission in the second emission mode is set shorter than the emission time Tx for violet, blue, green and red light emission in the first emission mode.

Even with differences in color mixture of the numerous pixels due to a body part of the object of interest, the color mixture is corrected for each of the pixels by performing the subtraction in the subtractor 79 for each of the pixels. It is therefore possible reliably to prevent occurrence of poor quality of the color rendering.

The high quality image formed by the high quality image generator 60 is according to the B1 corrected image signal, so that the top surface blood vessels and surface blood vessels are clearly imaged by prevention of occurrence of a poor quality of the color rendering. The top surface blood vessels are specifically important information for diagnosis of a lesion of a cancer or the like. Displaying the high quality image on the monitor display panel 18 with the top surface blood vessels in the clarified form can provide important information to a doctor for diagnosis of the cancer or other lesions.

### Second Embodiment

In the first embodiment, the light source controller 22 performs the green light emission in the second emission mode. In contrast, the light source controller 22 in a second embodiment performs violet, blue and red light emission for simultaneously emitting violet, blue and red light V, B and R in addition to the green light emission. Elements similar to those of the first embodiment are designated with identical reference numerals.

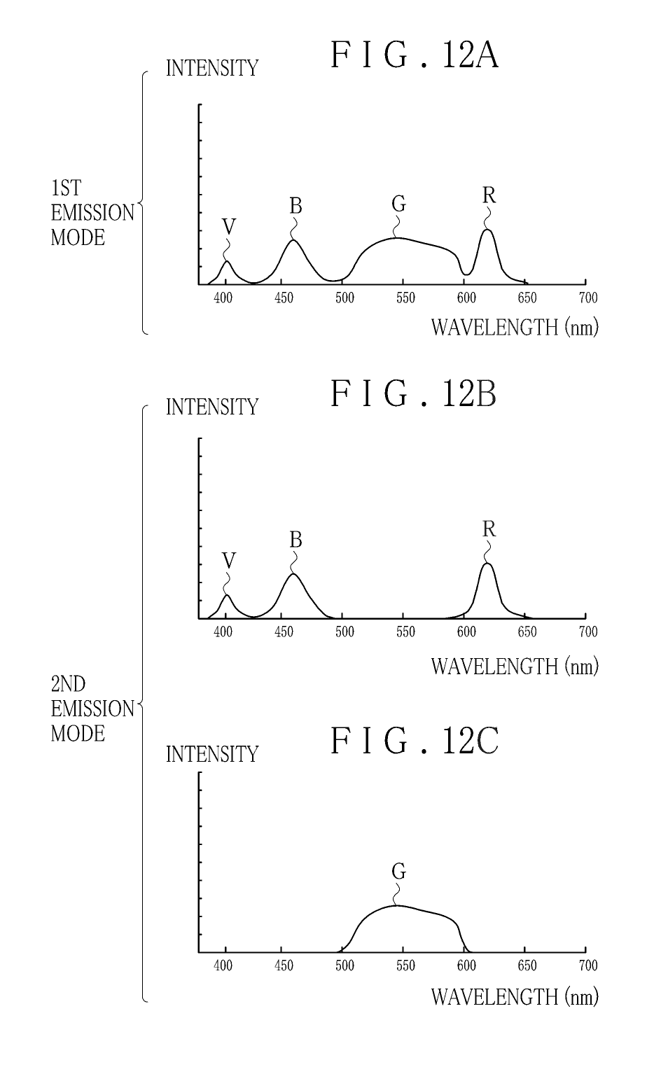

In the second embodiment, the light source controller 22 changes over between the first and second emission modes as illustrated in FIGS. 12A-12C. In FIG. 12A, the light source controller 22 in the first emission mode performs the violet, blue, green and red light emission in the same manner as the first embodiment.

The light source controller 22 in the second emission mode performs the violet, blue and red light emission and the green light emission. In the violet, blue and red light emission, the light source controller 22 in FIG. 12B turns on the violet, blue and red LEDs 20a, 20b and 20d and turns off only the green LED 20c among the LEDs 20a-20d, for simultaneously emitting violet, blue and red light V, B and R. In short, the violet, blue and red light V, B and R is emitted as partial light of the violet, blue, green and red light V, B, G and R emitted in the first emission mode.

In FIG. 12C, the light source controller 22 in the green light emission performs light emission of only green light G in the same manner as the first embodiment. The green light G is emitted in the green light emission of the second emission mode as partial light included in the violet, blue, green and red light V, B, G and R emitted in the first emission mode.

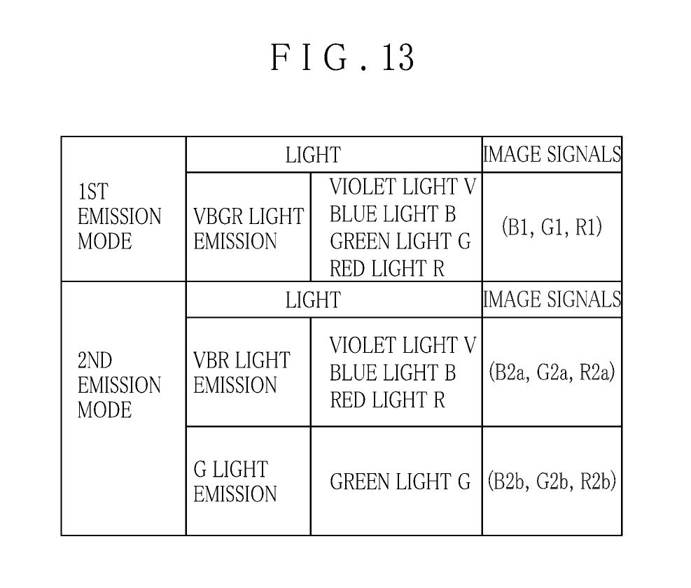

In FIG. 13, the imaging controller 40 controls imaging of one frame of an image of the object of interest illuminated in the violet, blue, green and red light emission (VBGR) in the first emission mode in the same manner as the above embodiment. Thus, the color image sensor 36 outputs B1, G1 and R1 image signals.

In the second emission mode, the imaging controller 40 performs imaging of one frame of an image of the object of interest illuminated in violet, blue and red light emission. Thus, the blue pixels in the color image sensor 36 output a B2a image signal. The green pixels output a G2a image signal. The red pixels output an R2a image signal.

The imaging controller 40 performs imaging of one frame of an image of the object of interest illuminated in green light emission. Thus, the blue pixels in the color image sensor 36 output a B2b image signal. The green pixels output a G2b image signal. The red pixels output an R2b image signal.

The storage medium 78 stores the B1, G1 and R1 image signals obtained in the violet, blue, green and red light emission in the first emission mode, stores the B2a, G2a and R2a image signals obtained in the violet, blue and red light emission in the second emission mode, and stores the B2b, G2b and R2b image signals obtained in the green light emission in the second emission mode.

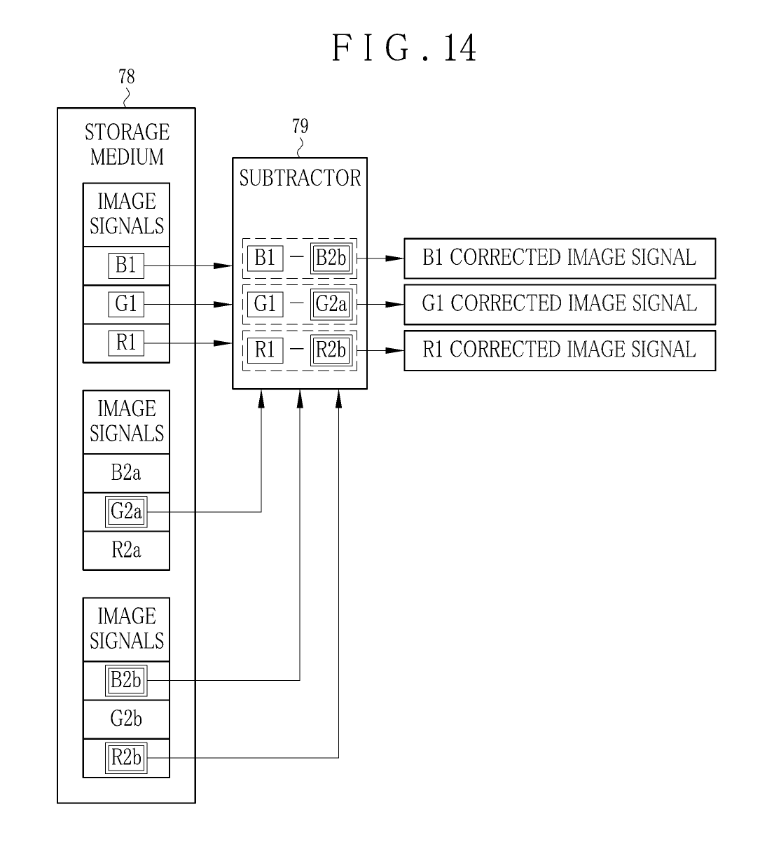

The subtractor 79 performs subtraction for the B1, G1 and R1 image signals output in the first emission mode by use of the image signals output in the second emission mode. In FIG. 14, the subtractor 79 subtracts the B2b image signal output by the blue pixels in the green light emission in the second emission mode from the B1 image signal output by the blue pixels in the first emission mode. Thus, a B1 corrected image signal is obtained, in which the color rendering is corrected.

The subtractor 79 subtracts the G2a image signal output by the green pixels in the violet, blue and red light emission in the second emission mode from the G1 image signal output by the green pixels in the first emission mode. The G1 image signal is an image signal obtained by the green pixels receiving returned light of green light G and partial returned light of the violet, blue and red light V, B and R, and leads to poor color rendering of imaging. The G2a image signal is an image signal obtained by the green pixels receiving partial returned light of the violet, blue and red light V, B and R. Thus, the subtraction of the image signals obtains a G1 corrected image signal, with which the color rendering is corrected.

The subtractor 79 subtracts the R2b image signal output by the red pixels in the green light emission in the second emission mode from the R1 image signal output by the red pixels in the first emission mode. The R1 image signal is an image signal obtained by the red pixels receiving returned light of red light R and partial returned light of the green light G, and leads to poor color rendering of imaging. The R2b image signal is an image signal obtained by the red pixels receiving partial returned light of the green light G. Thus, the subtraction of the image signals obtains an R1 corrected image signal, with which the color rendering is corrected.

The high quality image generator 60 generates the high quality image according to the B1, G1 and R1 corrected image signals.

In conclusion, the B2b image signal output in the green light emission in the second emission mode is subtracted from the B1 image signal output in the first emission mode. The G2a image signal output in the violet, blue and red light emission in the second emission mode is subtracted from the G1 image signal output in the first emission mode. The R2b image signal output in the green light emission in the second emission mode is subtracted from the R1 image signal output in the first emission mode. Thus, occurrence of poor quality in the color rendering of an object of interest can be prevented in a further reliable manner according to the second embodiment.

### Third Embodiment

In contrast with the first embodiment of performing the violet, blue, green and red light emission in the first emission mode in the light source controller 22, blue and red light emission and violet and green light emission are performed in a third embodiment in place of the violet, blue, green and red light emission.

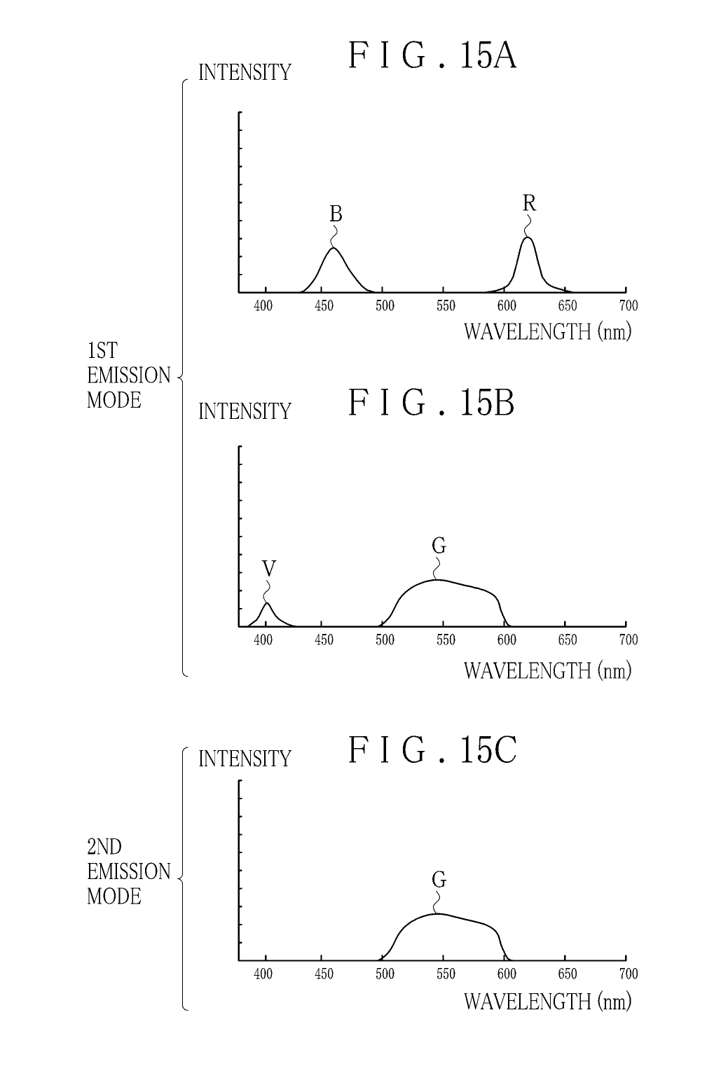

The light source controller 22 performs changeover between the first and second emission modes as illustrated in FIGS. 15A-15C.

For the blue and red light emission in the first emission mode, the light source controller 22 in FIG. 15A turns on the blue LED 20b and the red LED 20d among the LEDs 20a-20d and turns off the violet LED 20a and the green LED 20c, so that blue and red light B and R is emitted simultaneously.

For the violet and green light emission in the first emission mode, the light source controller 22 in FIG. 15B turns on the violet LED 20a and the green LED 20c and turns off the blue LED 20b and the red LED 20d, so that violet and green light V and G is emitted simultaneously.

In the second emission mode, the light source controller 22 performs the green light emission in FIG. 15C in the same manner as the first embodiment.

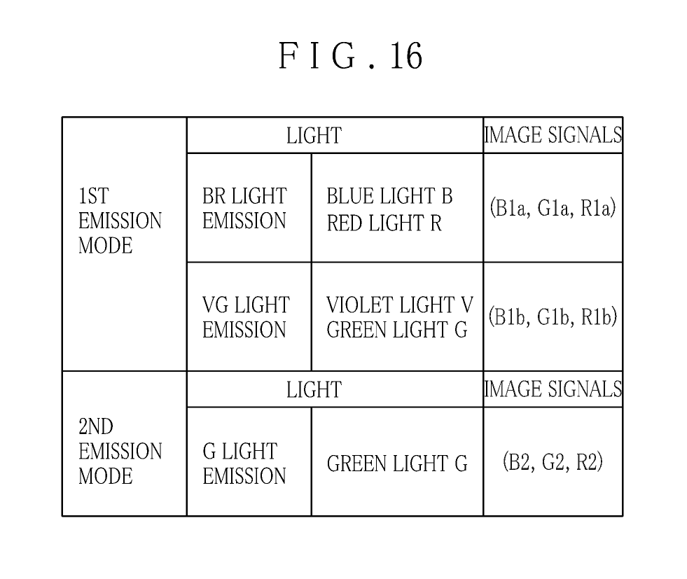

In FIG. 16, the imaging controller 40 in the first emission mode performs imaging of one frame of an image of an object of interest illuminated by the blue and red light emission. Thus, the blue pixels in the color image sensor 36 output a B1a image signal. The green pixels output a G1a image signal. The red pixels output an R1a image signal.

Also, the imaging controller 40 performs imaging of one frame of an image of the object of interest illuminated by the violet and green light emission. Thus, the blue pixels in the color image sensor 36 output a B1b image signal. The green pixels output a G1b image signal. The red pixels output an R1b image signal.

In the second emission mode, the imaging controller 40 controls imaging of one frame of an image of the object of interest illuminated by the green light emission. Thus, the color image sensor 36 outputs B2, G2 and R2 image signals.

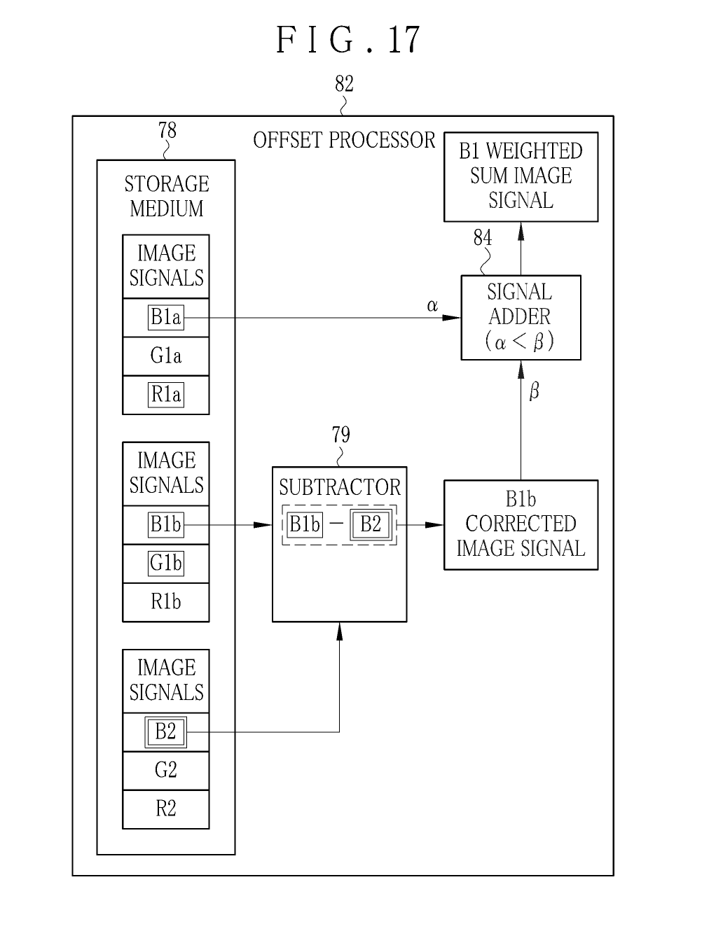

In the third embodiment, an offset processor 82 of FIG. 17 is provided in place of the offset processor 71 of the first embodiment. The offset processor 82 includes a signal adder 84 in addition to the storage medium 78 and the subtractor 79 of the offset processor 71.

The storage medium 78 stores the B1a, G1a and R1a image signals obtained in the blue and red light emission in the first emission mode, stores the B1b, G1b and R1b image signals obtained in the violet and green light emission in the first emission mode, and stores the B2, G2 and R2 image signals obtained in the green light emission in the second emission mode.

The subtractor 79 subtracts the B2 image signal output by the blue pixels in the green light emission in the second emission mode from the B1b image signal output by the blue pixels in the violet and green light emission in the first emission mode. The B1b image signal is an image signal obtained by the blue pixels receiving returned light of violet light V and partial returned light of the green light G, and leads to poor color rendering of imaging. The B2 image signal is an image signal obtained by the blue pixels receiving partial returned light of the green light G. Thus, the subtraction of the image signals obtains the B1b corrected image signal, with which the color rendering is corrected.

The signal adder 84 performs weighting and addition of the B1a image signal output in the blue and red light emission in the first emission mode and the B1b corrected image signal after correcting the color rendering by the subtraction described above, to obtain a B1 weighted sum image signal. For example, let α be a weighting coefficient for the B1a image signal. Let β be a weighting coefficient for the B1b corrected image signal. The weighting is performed to satisfy a condition of α<β. Specifically, the B1a image signal and the B1b corrected image signal are weighted at a ratio of “1:2” for the addition. The addition is performed for each of all the pixels.

The high quality image generator 60 generates a high quality image according to the B1 weighted sum image signal, and the G1b and R1a image signals.

In the third embodiment, the B2 image signal output in the green light emission in the second emission mode is subtracted from the B1b image signal output in the violet and green light emission in the first emission mode. Occurrence of a poor quality of color rendering of the object of interest can be prevented reliably.

Furthermore, the weighting coefficient for the B1b corrected image signal is set larger than the weighting coefficient for the B1a image signal in the course of addition of the B1a image signal and the B1b corrected image signal. Thus, the high quality image in which the top surface blood vessels are more clearly expressed than the surface blood vessels can be displayed.

In the third embodiment, the weighting coefficient for the B1b corrected image signal is set higher than the weighting coefficient for the B1a image signal in the course of creating the B1 weighted sum image signal in the signal adder 84. However, the weighting coefficient for the B1a image signal can be set higher than the weighting coefficient for the B1b corrected image signal. It is possible to display a high quality image in which top surface blood vessels are expressed more clearly than surface blood vessels. In short, the weighting coefficients can be changed suitably for satisfying purposes.

### Fourth Embodiment

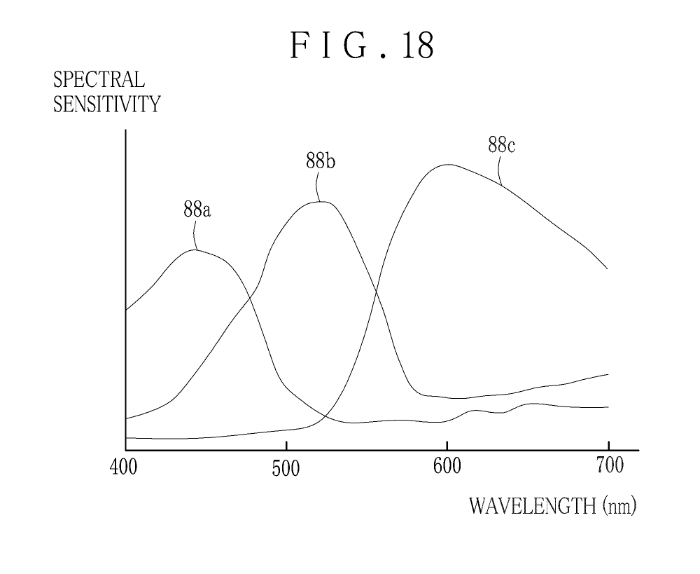

In the first embodiment, the pixels 37 in the color image sensor 36 have the color filters 38a-38c of blue, green and red with comparatively good color separation without remarkable color mixture of other colors. See FIG. 7. In FIG. 18, the color image sensor of a fourth embodiment is illustrated. A blue color filter 88a, a green color filter 88b and a red color filter 88c are provided in the pixels 37 and have comparatively poor color separation with high risk of color mixture of other colors.

The blue pixels having the blue color filter 88a among the pixels 37 are sensitive not only to violet and blue light V and B but also to green and red light G and R to a small extent. The green pixels having the green color filter 88b among the pixels 37 are sensitive not only to green light G but also to violet, blue and red light V, B and R to a small extent. The red pixels having the red color filter 88c among the pixels 37 are sensitive not only to red light R but also to violet, blue and green light V, B and G to a small extent.

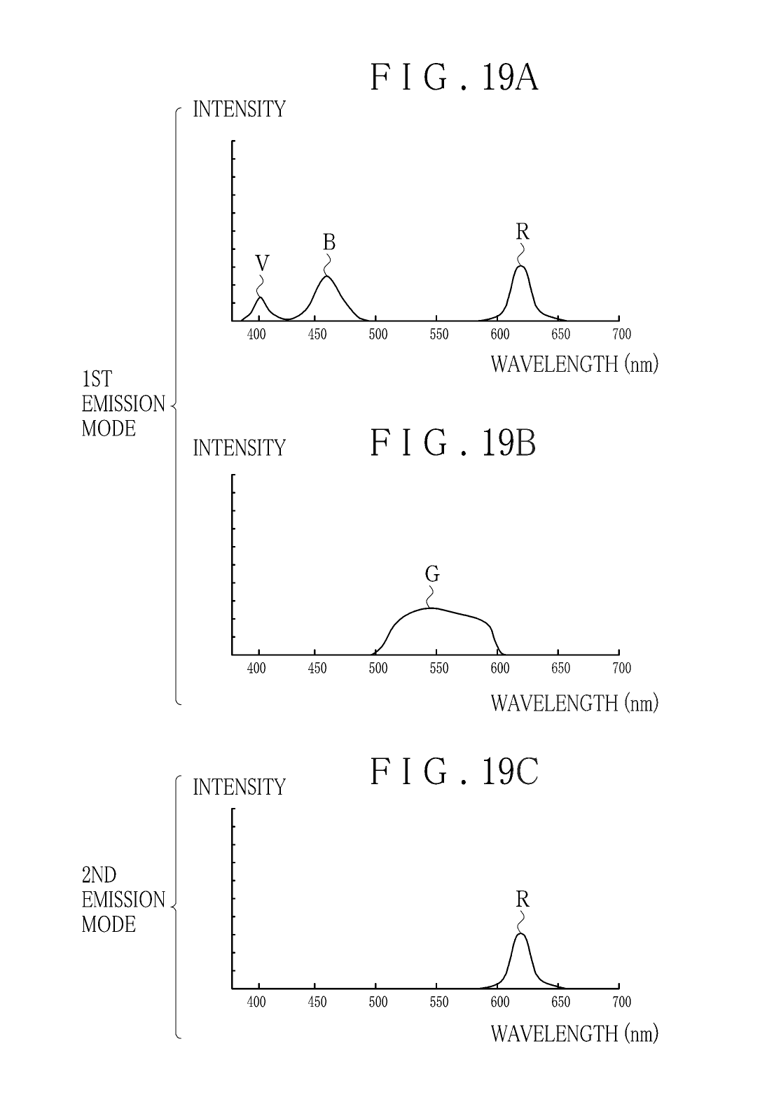

In FIGS. 19A-19C, the light source controller 22 in the fourth embodiment performs control of changing over the first and second emission modes.

In the first emission mode, the light source controller 22 performs the violet, blue and red light emission and the green light emission. In the violet, blue and red light emission, the light source controller 22 performs simultaneous light emission of violet, blue and red light V, B and R as illustrated in FIG. 19A. In the green light emission, the light source controller 22 performs light emission of only green light G as illustrated in FIG. 19B.

In the second emission mode, the light source controller 22 in FIG. 19C turns on only the red LED 20d among the LEDs 20a-20d and turns off the remainder, to perform the red light emission of emitting only the red light R.

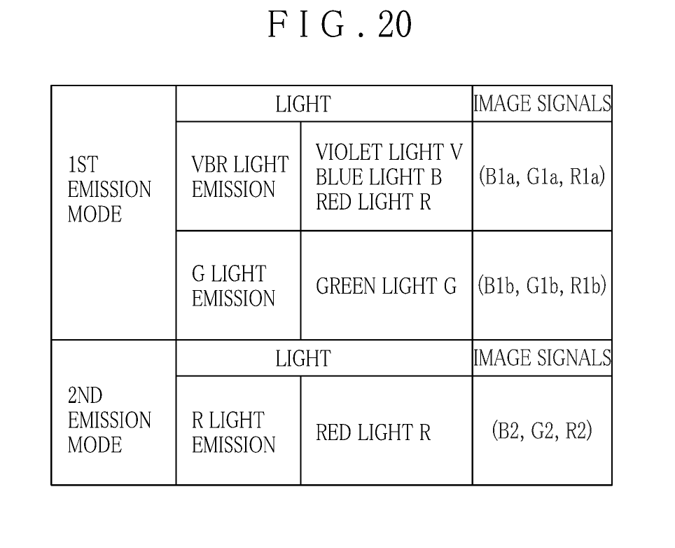

In FIG. 20, the imaging controller 40 in the first emission mode performs imaging of one frame of an image of an object of interest illuminated in violet, blue and red light emission. Thus, the blue pixels in the color image sensor 36 output a B1a image signal. The green pixels output a G1a image signal. The red pixels output an R1a image signal. Also, the imaging controller 40 performs imaging of one frame of an image of the object of interest illuminated in green light emission. Thus, the blue pixels in the color image sensor 36 output a B1b image signal. The green pixels output a G1b image signal. The red pixels output an R1b image signal.

In the second emission mode, the imaging controller 40 performs imaging of one frame of an image of the object of interest illuminated in red light emission. Thus, the blue pixels in the color image sensor 36 output a B2 image signal. The green pixels output a G2 image signal. The red pixels output an R2 image signal.

The storage medium 78 stores the B1a, G1a and R1a image signals obtained in the violet, blue and red light emission in the first emission mode, stores the B1b, G1b and R1b image signals obtained in the green light emission in the first emission mode, and stores the B2, G2 and R2 image signals obtained in the red light emission in the second emission mode.

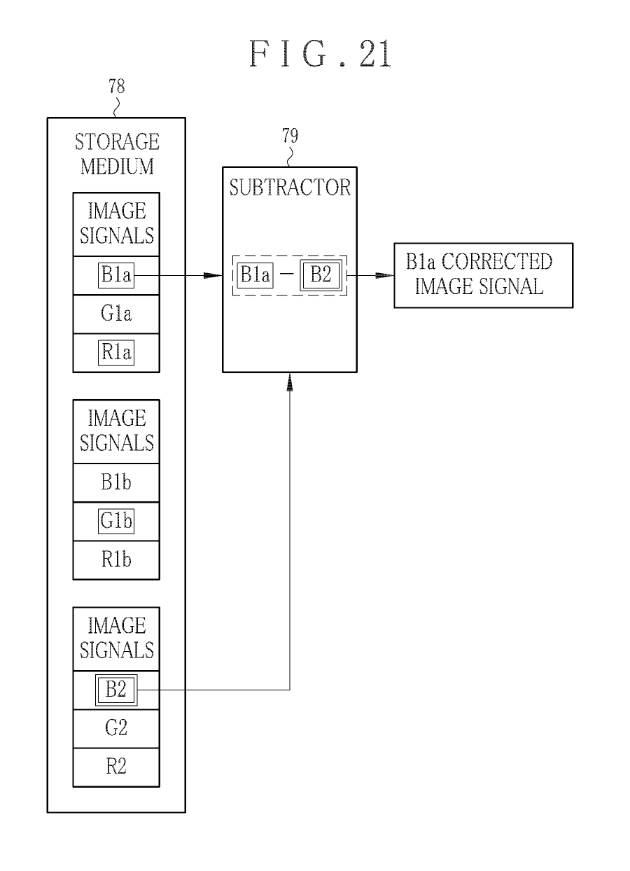

In FIG. 21, the subtractor 79 subtracts the B2 image signal output by the blue pixels in the red light emission in the second emission mode from the B1a image signal output by the blue pixels in the violet, blue and red light emission in the first emission mode. The B1a image signal is an image signal obtained by the blue pixels receiving returned light of violet and blue light V and B and partial returned light of the red light R, and leads to poor color rendering of imaging. The B2 image signal is an image signal obtained by the blue pixels receiving partial returned light of the red light R. Thus, the subtraction of the image signals obtains the B1a corrected image signal, with which the color rendering is corrected.

Accordingly, it is possible in the fourth embodiment reliably to prevent occurrence of poor quality of the color rendering of an object of interest even by use of the color image sensor with the color filters 88a-88c of blue, green and red with insufficient color separation for the purpose of imaging of the object of interest.

### Fifth Embodiment

In the fourth embodiment, the light source controller 22 performs the subtraction from the B1a image signal output by the blue pixels in the violet, blue and red light emission in the first emission mode. However, the light source controller 22 in the fifth embodiment performs subtraction from the R1a image signal output by the red pixels.

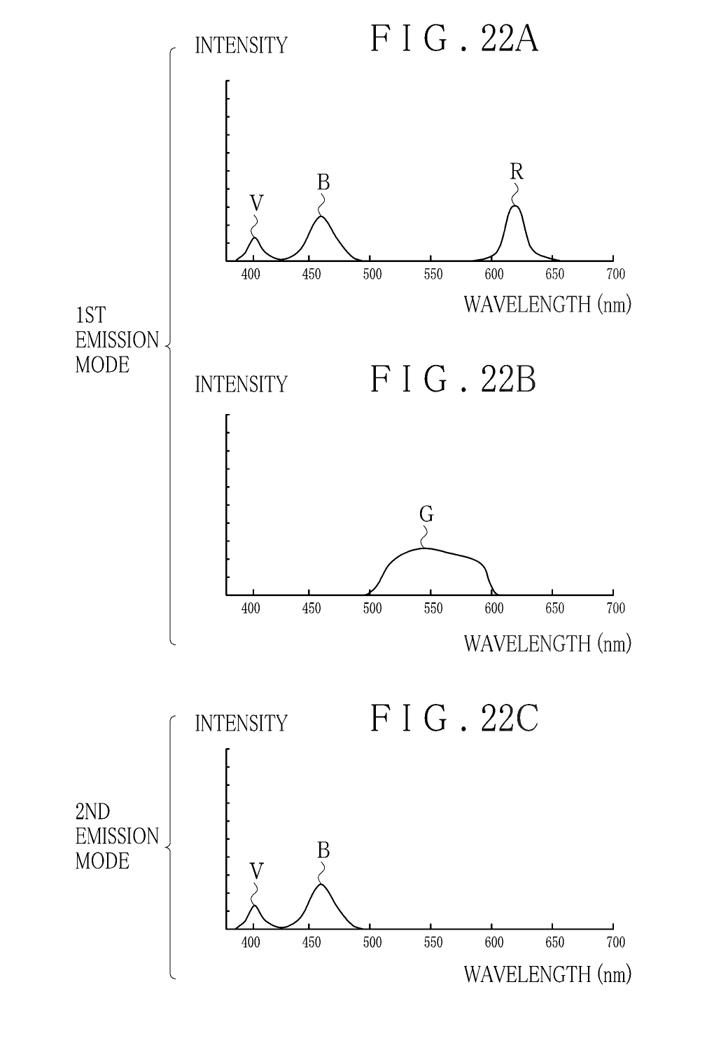

In the fifth embodiment in FIGS. 22A-22C, the light source controller 22 controls changeover between the first and second emission modes. In the first emission mode, the light source controller 22 performs the violet, blue and red light emission of FIG. 22A and the green light emission of FIG. 22B in the same manner as the fourth embodiment.

In the second emission mode, the light source controller 22 in FIG. 22C turns on the violet LED 20a and the blue LED 20b and turns off the green LED 20c and the red LED 20d among the LEDs 20a-20d, for simultaneously emitting violet and blue light V and B in violet and blue light emission.

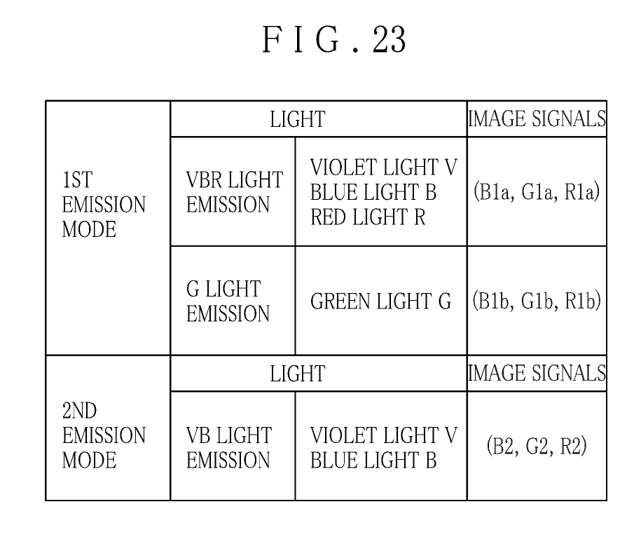

In FIG. 23, the imaging controller 40 in the first emission mode causes the color image sensor 36 to output the B1a, G1a and R1a image signals for the violet, blue and red light emission, and output the B1b, G1b and R1b image signals for the green light emission, in the same manner as the fourth embodiment.

The imaging controller 40 in the second emission mode performs imaging of one frame of an image of the object of interest illuminated in the violet and blue light emission. Thus, the blue pixels in the color image sensor 36 output a B2 image signal. The green pixels output a G2 image signal. The red pixels output an R2 image signal.

The storage medium 78 stores the B1a, G1a and R1a image signals obtained in the violet, blue and red light emission in the first emission mode, stores the B1b, G1b and R1b image signals obtained in the green light emission in the first emission mode, and stores the B2, G2 and R2 image signals obtained in the violet and blue light emission in the second emission mode.

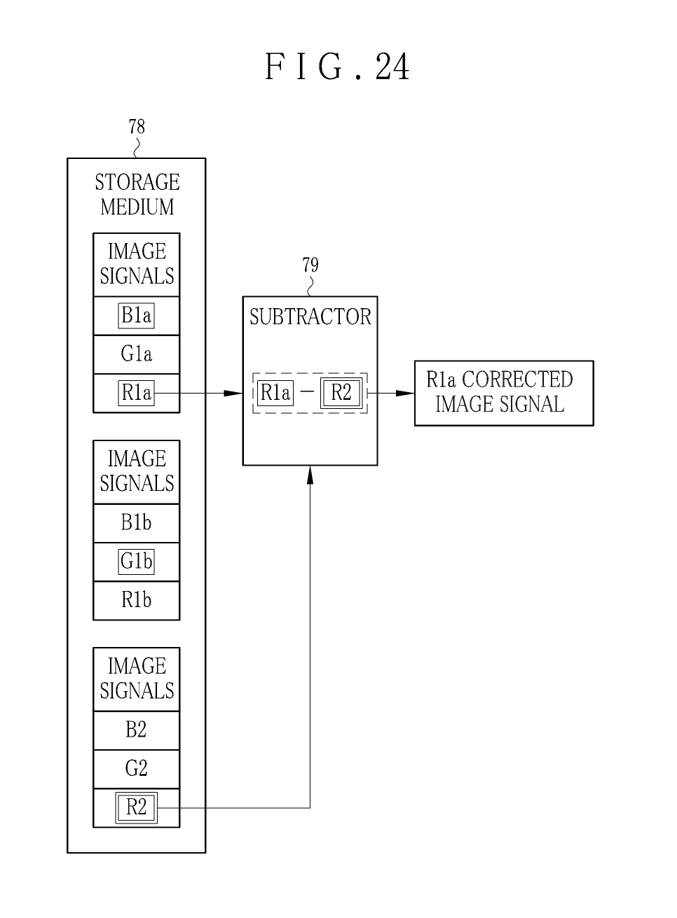

In FIG. 24, the subtractor 79 subtracts the R2 image signal output by the red pixels in the violet and blue light emission in the second emission mode from the R1a image signal output by the red pixels in the violet, blue and red light emission in the first emission mode. The R1a image signal is an image signal obtained by the red pixels receiving partial returned light of violet and blue light V and B and returned light of the red light R, and leads to poor color rendering of imaging. The R2 image signal is an image signal obtained by the red pixels receiving partial returned light of the violet and blue light V and B. Thus, the subtraction of the image signals obtains the R1a corrected image signal, with which the color rendering is corrected.

Accordingly, it is possible in the fifth embodiment reliably to prevent occurrence of poor quality of the color rendering of an object of interest even by use of the color image sensor with the color filters 88a-88c of blue, green and red with insufficient color separation for the purpose of imaging of the object of interest.

### Sixth Embodiment

All the LEDs are turned on in the first emission mode in the same manner as the first embodiment. However, intensity of light from the LEDs is different from that according to the first embodiment.

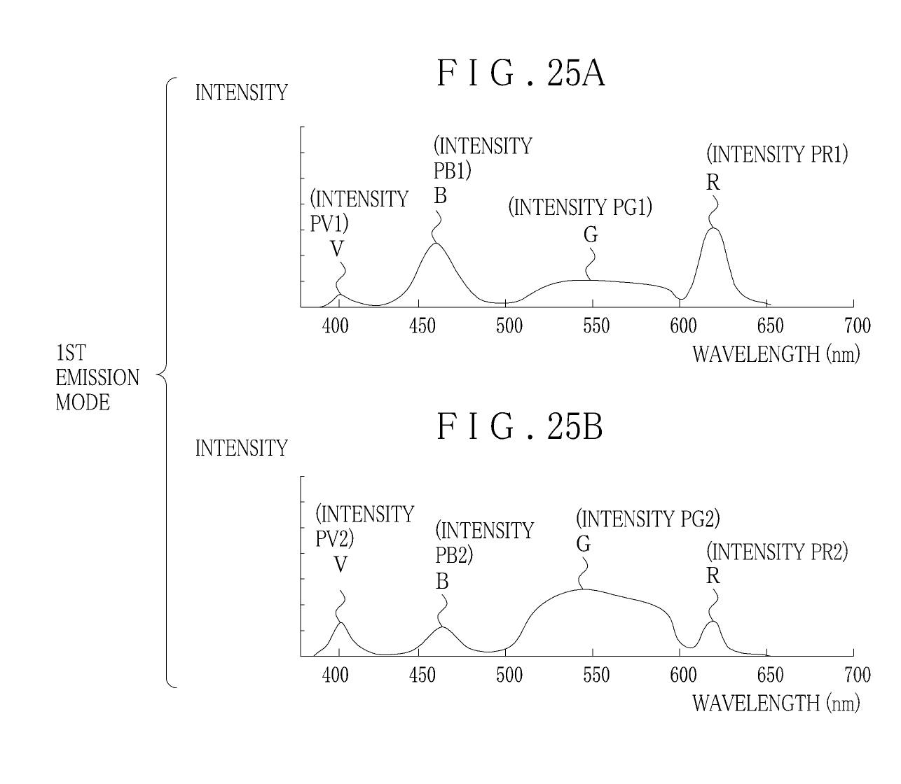

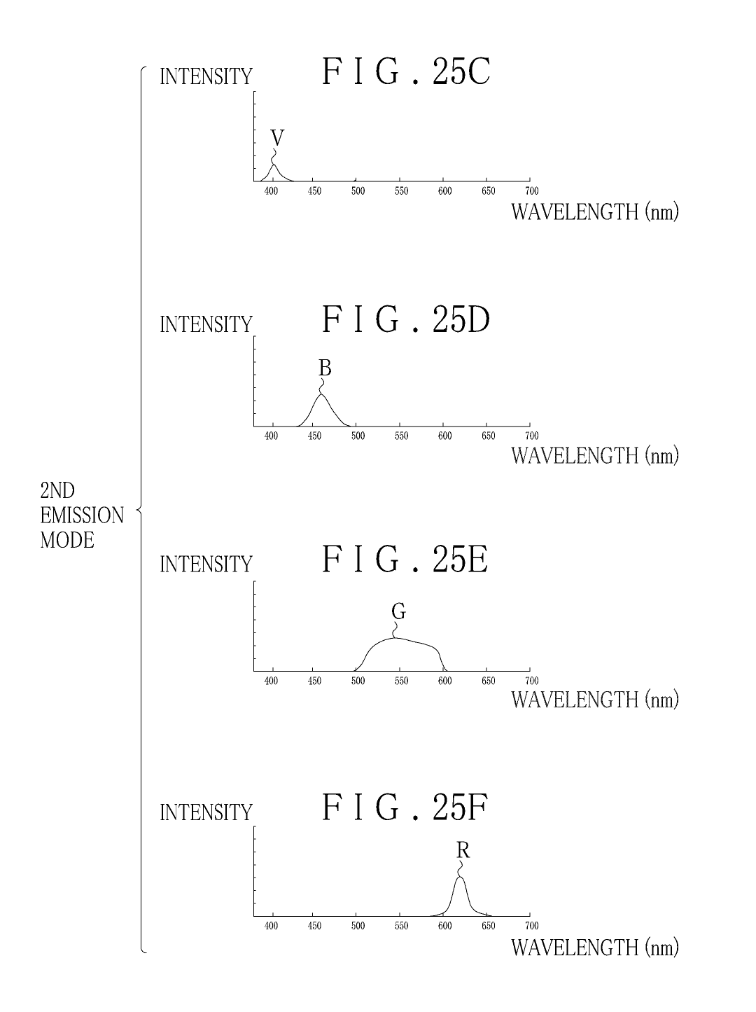

In the sixth embodiment in FIGS. 25A and 25B, the light source controller 22 controls changeover between the first and second emission modes.

In the first emission mode, the light source controller 22 performs the first and second violet, blue, green and red light emission. The light source controller 22 in the first and second violet, blue, green and red light emission turns on all the LEDs 20a-20d to emit violet, blue, green and red light V, B, G and R simultaneously.

In the first violet, blue, green and red light emission, the light source controller 22 in FIG. 25A sets intensity of violet light V equal to the intensity PB1, sets intensity of blue light B equal to the intensity PB1, sets intensity of green light G equal to the intensity PG1, and sets intensity of red light R equal to the intensity PR1.

In the second violet, blue, green and red light emission, the light source controller 22 in FIG. 25B sets intensity of violet light V equal to the intensity PV2, sets intensity of blue light B equal to the intensity PB2, sets intensity of green light G equal to the intensity PG2, and sets intensity of red light R equal to the intensity PR2.

The light source controller 22 controls the LEDs 20a-20d in such a manner that the intensities of the violet, blue, green and red light V, B, G and R are different between the first violet, blue, green and red light emission (VBGR) and the second violet, blue, green and red light emission.

Specifically, for the intensity of the violet light V, the violet LED 20a is controlled in the first violet, blue, green and red light emission and second violet, blue, green and red light emission in such a manner that the intensities PV1 and PV2 satisfy a condition of PV1<PV2. For example, the intensity PV1 is set 1/10 as high as the intensity PV2.

For the intensity of the blue light B, the blue LED 20b is controlled in the first violet, blue, green and red light emission and second violet, blue, green and red light emission in such a manner that the intensities PB1 and PB2 satisfy a condition of PB1>PB2. For example, the intensity PB2 is set 1/10 as high as the intensity PB1.

For the intensity of the green light G, the green LED 20c is controlled in the first violet, blue, green and red light emission and second violet, blue, green and red light emission in such a manner that the intensities PG1 and PG2 satisfy a condition of PG1<PG2. For example, the intensity PG1 is set 1/10 as high as the intensity PG2.

For the intensity of the red light R, the red LED 20d is controlled in the first violet, blue, green and red light emission and second violet, blue, green and red light emission in such a manner that the intensities PR1 and PR2 satisfy a condition of PR1>PR2. For example, the intensity PR2 is set 1/10 as high as the intensity PR1.

In the first violet, blue, green and red light emission, violet, blue, green and red light V, B, G and R is simultaneously emitted. In relation to spectral distribution, intensity PB1 of the blue light B and intensity PR1 of the red light R are higher than respectively intensity PB2 of the blue light B and intensity PR2 of the red light R in the second violet, blue, green and red light emission. However, intensity PV1 of the violet light V and intensity PG1 of the green light G are higher than respectively intensity PV2 of the violet light V and intensity PG2 of the green light G in the second violet, blue, green and red light emission.

In the second violet, blue, green and red light emission, violet, blue, green and red light V, B, G and R is simultaneously emitted. In relation to spectral distribution, the intensity PV2 of the violet light V and the intensity PG2 of the green light G are higher than respectively the intensity PV1 of the violet light V and the intensity PG1 of the green light G in the first violet, blue, green and red light emission. However, the intensity PB2 of the blue light B and the intensity PR2 of the red light R are higher than respectively the intensity PB1 of the blue light B and the intensity PR1 of the red light R in the first violet, blue, green and red light emission.

In the second emission mode, the light source controller 22 performs the violet light emission, blue light emission, green light emission and red light emission.

In FIG. 25C, the light source controller 22 for the violet light emission turns on only the violet LED 20a among the LEDs 20a-20d, and turns off the remainder of those, so as to emit violet light V only. For example, the light source controller 22 sets an intensity of the violet light V in the violet light emission equal to the intensity PV2.

In FIG. 25D, the light source controller 22 for the blue light emission turns on only the blue LED 20b, and turns off the remainder of the LEDs, so as to emit blue light B only. For example, the light source controller 22 sets an intensity of the blue light B in the blue light emission equal to the intensity PB1.

In the green light emission, the light source controller 22 in FIG. 25E performs light emission of only green light G. For example, the light source controller 22 sets intensity of green light G equal to the intensity PG2.

In the red light emission, the light source controller 22 in FIG. 25F performs light emission of only red light R. For example, the light source controller 22 sets intensity of red light R equal to the intensity PR1.

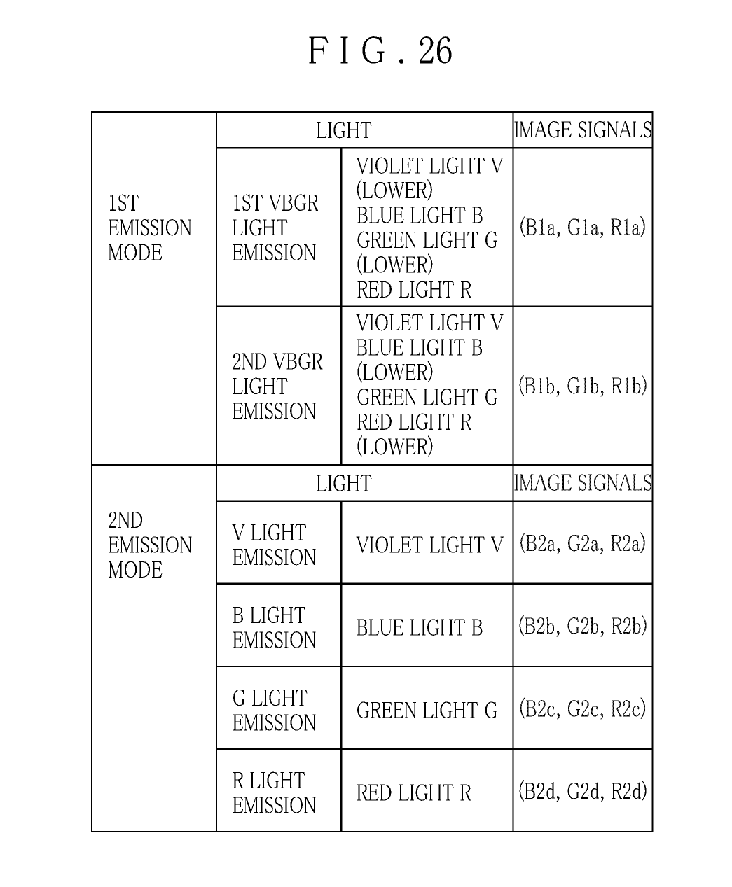

In FIG. 26, the imaging controller 40 in the first emission mode performs imaging of one frame of an image of an object of interest illuminated in the first violet, blue, green and red light emission. Thus, the blue pixels in the color image sensor 36 output a B1a image signal. The green pixels output a G1a image signal. The red pixels output an R1a image signal. Also, the imaging controller 40 performs imaging of one frame of an image of the object of interest illuminated in the second violet, blue, green and red light emission. Thus, the blue pixels in the color image sensor 36 output a B1b image signal. The green pixels output a G1b image signal. The red pixels output an R1b image signal.

Upon the violet light emission in the second emission mode, the imaging controller 40 performs imaging of one frame of an image of the object of interest illuminated by the violet light emission, so that the blue pixels in the color image sensor 36 output the B2a image signal, the green pixels output the G2a image signal, and the red pixels output the R2a image signal.

Upon the blue light emission, the imaging controller 40 performs imaging of one frame of an image of the object of interest illuminated by the blue light emission, so that the blue pixels in the color image sensor 36 output the B2b image signal, the green pixels output the G2b image signal, and the red pixels output the R2b image signal.

Upon the green light emission, the imaging controller 40 performs imaging of one frame of an image of the object of interest illuminated by the green light emission, so that the blue pixels in the color image sensor 36 output the B2c image signal, the green pixels output the G2c image signal, and the red pixels output the R2c image signal.

Upon the red light emission, the imaging controller 40 performs imaging of one frame of an image of the object of interest illuminated by the red light emission, so that the blue pixels in the color image sensor 36 output the B2d image signal, the green pixels output the G2d image signal, and the red pixels output the R2d image signal.

In the first emission mode, the storage medium 78 stores the B1a, G1a and R1a image signals obtained in the first violet, blue, green and red light emission, and stores the B1b, G1b and R1b image signals obtained in the second violet, blue, green and red light emission. In the second emission mode, the storage medium 78 stores the B2a, G2a and R2a image signals obtained in the violet light emission, stores the B2b, G2b and R2b image signals obtained in the blue light emission, stores the B2c, G2c and R2c image signals obtained in the green light emission, and stores the B2d, G2d and R2d image signals obtained in the red light emission.

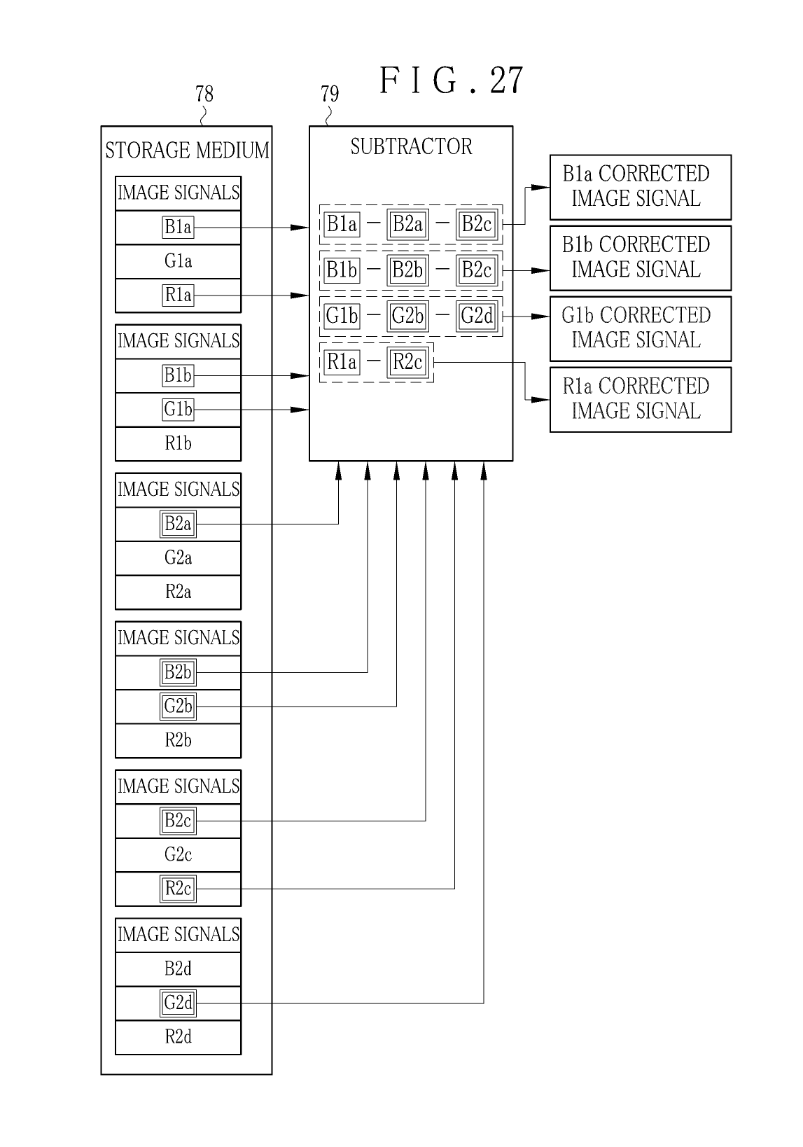

In FIG. 27, the subtractor 79 subtracts the B2a image signal and the B2c image signal from the B1a image signal, the B2a image signal being output by the blue pixels in the violet light emission in the second emission mode, the B2c image signal being output by the blue pixels in the green light emission in the second emission mode, the B1a image signal being output by the blue pixels in the first violet, blue, green and red light emission in the first emission mode. The B1a image signal is a signal formed by receiving not only returned light of blue light B with the blue pixels but also partial returned light of violet and green light V and G with the blue pixels, so that color rendering of an image may become poorer. The B2a image signal is formed by receiving only partial returned light of violet light V with the blue pixels. The B2c image signal is formed by receiving only partial returned light of green light G with the blue pixels. A B1a corrected image signal can be obtained in a form of correcting the color rendering by the subtraction of the B2a image signal and the B2c image signal from the B1a image signal (namely, B1a−B2a−B2c).

The subtractor 79 subtracts the B2b image signal and the B2c image signal from the B1b image signal, the B2b image signal being output by the blue pixels in the blue light emission in the second emission mode, the B2c image signal being output by the blue pixels in the green light emission in the second emission mode, the B1b image signal being output by the blue pixels in the second violet, blue, green and red light emission in the first emission mode. The B1b image signal is a signal formed by receiving not only returned light of violet light V with the blue pixels but also partial returned light of blue and green light B and G with the blue pixels, so that color rendering of an image may become poorer. The B2b image signal is formed by receiving only partial returned light of blue light B with the blue pixels. A B1b corrected image signal can be obtained in a form of correcting the color rendering by the subtraction of the B2b image signal and the B2c image signal from the B1b image signal (namely, B1b−B2b−B2c).

The subtractor 79 subtracts the G2b image signal and the G2d image signal from the G1b image signal, the G2b image signal being output by the green pixels in the blue light emission in the second emission mode, the G2d image signal being output by the green pixels in the red light emission in the second emission mode, the G1b image signal being output by the green pixels in the second violet, blue, green and red light emission in the first emission mode. The G1b image signal is a signal formed by receiving not only returned light of green light G with the green pixels but also partial returned light of blue and red light B and R with the green pixels, so that color rendering of an image may become poorer. The G2b image signal is formed by receiving only partial returned light of blue light B with the green pixels. The G2d image signal is formed by receiving only partial returned light of red light R with the green pixels. A G1b corrected image signal can be obtained in a form of correcting the color rendering by the subtraction of the G2b image signal and the G2d image signal from the G1b image signal (namely, G1b−G2b−G2d).

The subtractor 79 subtracts the R2c image signal output by the red pixels in the green light emission in the second emission mode from the R1a image signal output by the red pixels in the first violet, blue, green and red light emission in the first emission mode. The R1a image signal is an image signal obtained by the red pixels receiving returned light of red light R and partial returned light of the green light G, and leads to poor color rendering of imaging. The R2c image signal is an image signal obtained by the red pixels receiving partial returned light of the green light G. Thus, the subtraction of the image signals (R1a−R2c) obtains the R1a corrected image signal, with which the color rendering is corrected.

In the sixth embodiment, the B1 weighted sum image signal is obtained by weighting and addition of the B1a corrected image signal and B1b corrected image signal obtained in the subtraction described above. Furthermore, it is possible to use the signal adder 84 to obtain the B1 weighted sum image signal in the same manner as the third embodiment. The high quality image generator 60 forms a high quality image according to the B1 weighted sum image signal, the G1b corrected image signal and the R1a corrected image signal.

In the embodiment, the LEDs 20a-20d are kept turned on in the first emission mode. Time of startup, which is required for increase of the intensity of the colors up to a required intensity, is made shorter than a structure in which the LEDs 20a-20d are repeatedly turned on and off. Shortening the time of the startup is effective in obtaining a relatively long available period for imaging at the required intensity, so that brightness of the high quality image can be increased.

Also, it is possible in the second emission mode suitably to change intensities of light in the violet light emission, blue light emission, green light emission and red light emission. For example, an intensity of the violet light V in the violet light emission can be set equal to the intensity PV1. An intensity of the blue light B in the blue light emission can be set equal to the intensity PB2. An intensity of the green light G in the green light emission can be set equal to the intensity PG1. An intensity of the red light R in the red light emission can be set equal to the intensity PR2.

### Seventh Embodiment

All of the LEDs are turned on in the first emission mode to vary the intensities of light from the LEDs, in the same manner as the sixth embodiment. However, a difference of a seventh embodiment from the sixth embodiment lies in a pattern of the intensity of the light from the LEDs.

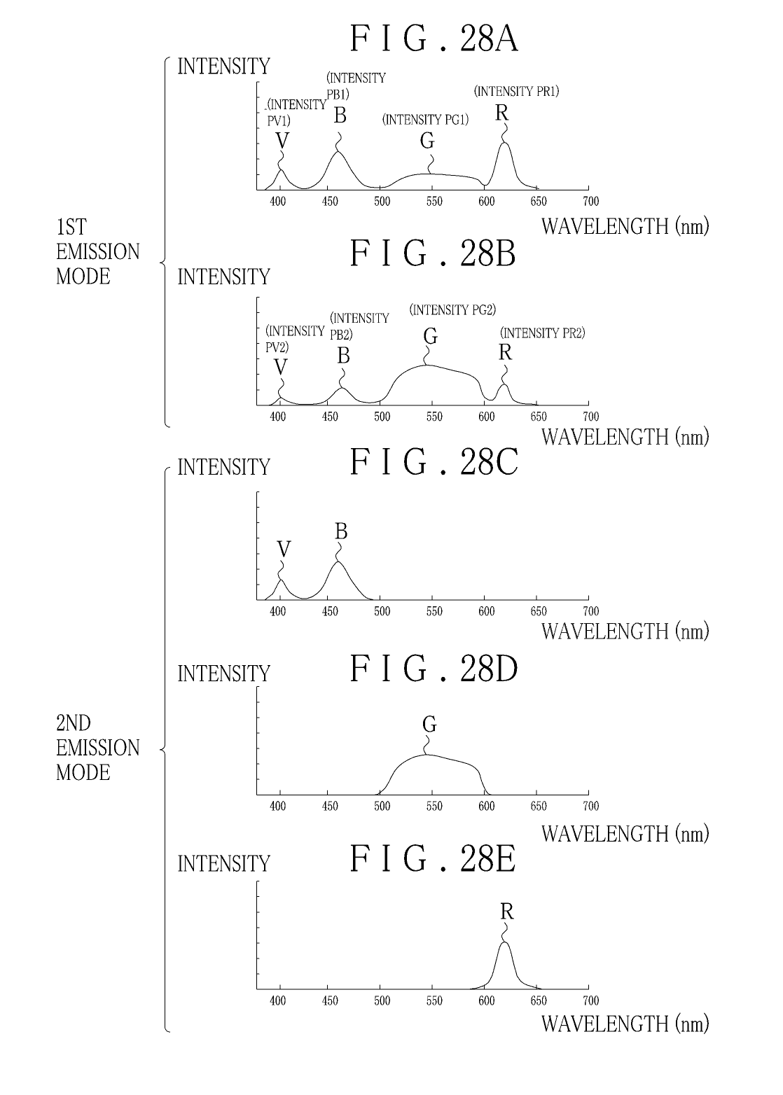

In the seventh embodiment in FIGS. 28A and 28B, the light source controller 22 controls changeover between the first and second emission modes.

For the first violet, blue, green and red light emission, the light source controller 22 in FIG. 28A sets an intensity PV1 for light emission of the violet light V, an intensity PB1 for light emission of the blue light B, an intensity PG1 for light emission of the green light G, and an intensity PR1 for light emission of the red light R.

For the second violet, blue, green and red light emission, the light source controller 22 in FIG. 28B sets an intensity PV2 for light emission of the violet light V, an intensity PB2 for light emission of the blue light B, an intensity PG2 for light emission of the green light G, and an intensity PR2 for light emission of the red light R.

For the intensity of the violet light V, the violet LED 20a is controlled in the first violet, blue, green and red light emission and second violet, blue, green and red light emission in such a manner that the intensities PV1 and PV2 satisfy a condition of PV1>PV2.

For the intensity of the blue light B, the blue LED 20b is controlled in the first violet, blue, green and red light emission and second violet, blue, green and red light emission in such a manner that the intensities PB1 and PB2 satisfy a condition of PB1>PB2.

For the intensity of the green light G, the green LED 20c is controlled in the first violet, blue, green and red light emission and second violet, blue, green and red light emission in such a manner that the intensities PG1 and PG2 satisfy a condition of PG1<PG2.

For the intensity of the red light R, the red LED 20d is controlled in the first violet, blue, green and red light emission and the second violet, blue, green and red light emission in such a manner that the intensities PR1 and PR2 satisfy a condition of PR1>PR2.

In the first violet, blue, green and red light emission, the violet light V has such a spectral distribution that the intensity PV1 of the violet light V is higher than the intensity PV2 of the violet light V in the second violet, blue, green and red light emission. The blue light B has such a spectral distribution that the intensity PB1 of the blue light B is higher than the intensity PB2 of the blue light B in the second violet, blue, green and red light emission. The red light R has such a spectral distribution that the intensity PR1 of the red light R is higher than the intensity PR2 of the red light R in the second violet, blue, green and red light emission. However, the green light G has such a spectral distribution that the intensity PG1 of the green light G is lower than the intensity PG2 of the green light G in the second violet, blue, green and red light emission.

In the second violet, blue, green and red light emission, the green light G has such a spectral distribution that the intensity PG2 of the green light G is higher than the intensity PG1 of the green light G in the first violet, blue, green and red light emission. However, the violet light V has such a spectral distribution that the intensity PV2 of the violet light V is lower than the intensity PV1 of the violet light V in the first violet, blue, green and red light emission. The blue light B has such a spectral distribution that the intensity PB2 of the blue light B is lower than the intensity PB1 of the blue light B in the first violet, blue, green and red light emission. The red light R has such a spectral distribution that the intensity PR2 of the red light R is lower than the intensity PR1 of the red light R in the first violet, blue, green and red light emission.

In the second emission mode, the light source controller 22 performs the violet and blue light emission, the green light emission and the red light emission.

For the violet and blue light emission, the light source controller 22 in FIG. 28C sets intensity of violet light V equal to the intensity PV1, and sets intensity of blue light B equal to the intensity PB1.

For the green light emission, the light source controller 22 in FIG. 28D sets intensity of green light G equal to the intensity PG2.

For the red light emission, the light source controller 22 in FIG. 28E sets intensity of red light R equal to the intensity PR1.

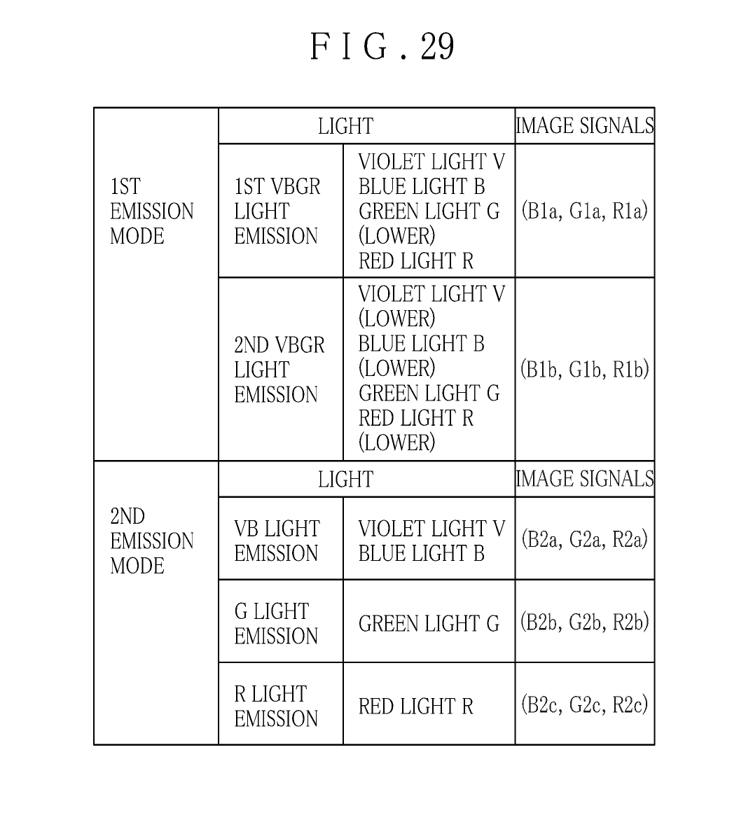

In FIG. 29, the imaging controller 40 in the first emission mode performs imaging of one frame of an image of an object of interest illuminated in the first violet, blue, green and red light emission. Thus, the color image sensor 36 outputs the B1a, G1a and R1a image signals. Also, the imaging controller 40 performs imaging of one frame of an image of the object of interest illuminated in the second violet, blue, green and red light emission. Thus, the color image sensor 36 outputs the B1b, G1b and R1b image signals.

In the second emission mode, the object of interest illuminated in the violet and blue light emission is imaged by the imaging controller 40 for one image frame. So the blue pixels in the color image sensor 36 are caused to output the B2a image signal. The green pixels in the color image sensor 36 are caused to output the G2a image signal. The red pixels in the color image sensor 36 are caused to output the R2a image signal.

The object of interest illuminated in the green light emission is imaged by the imaging controller 40 for one image frame. So the blue pixels in the color image sensor 36 are caused to output the B2b image signal. The green pixels in the color image sensor 36 are caused to output the G2b image signal. The red pixels in the color image sensor 36 are caused to output the R2b image signal.

The object of interest illuminated in the red light emission is imaged by the imaging controller 40 for one image frame. So the blue pixels in the color image sensor 36 are caused to output the B2c image signal. The green pixels in the color image sensor 36 are caused to output the G2c image signal. The red pixels in the color image sensor 36 are caused to output the R2c image signal.

In the first emission mode, the storage medium 78 stores the B1a, G1a and R1a image signals obtained in the first violet, blue, green and red light emission, and stores the B1b, G1b and R1b image signals obtained in the second violet, blue, green and red light emission. In the second emission mode, the storage medium 78 stores the B2a, G2a and R2a image signals obtained in the violet and blue light emission, stores the B2b, G2b and R2b image signals obtained in the green light emission, and stores the B2c, G2c and R2c image signals obtained in the red light emission.

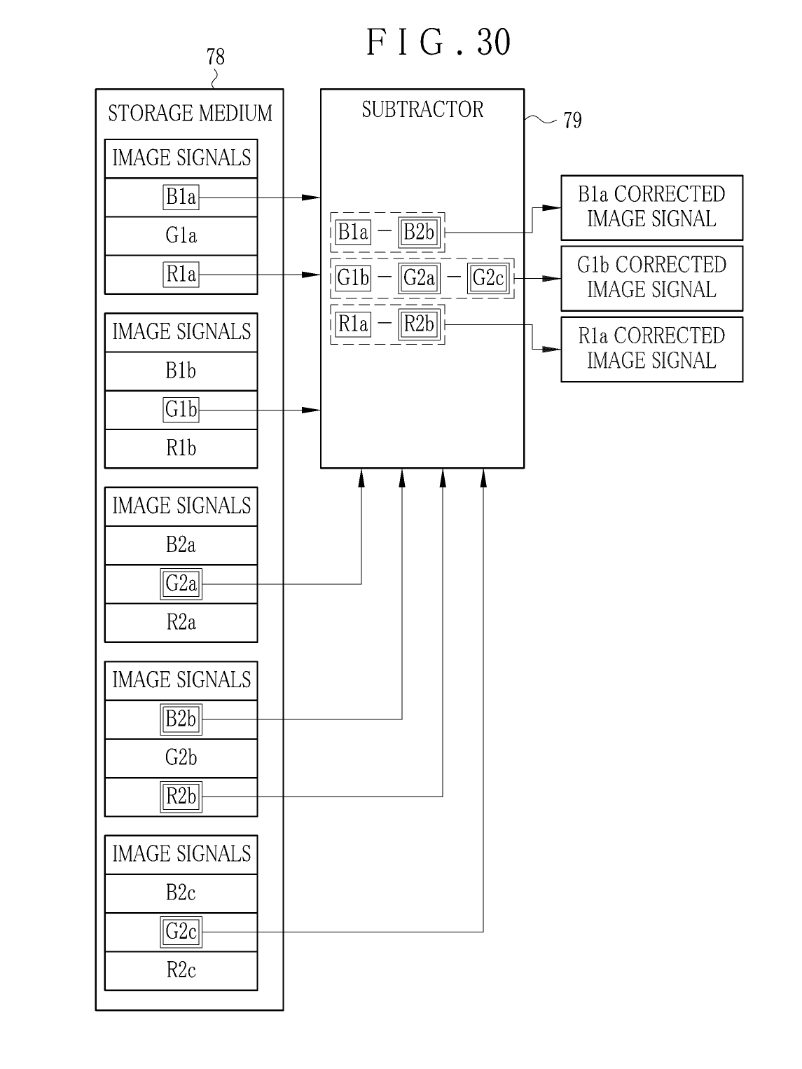

In FIG. 30, the subtractor 79 subtracts the B2b image signal output by the blue pixels in the green light emission in the second emission mode from the B1a image signal output by the blue pixels in the first violet, blue, green and red light emission in the first emission mode. Thus, the B1a corrected image signal is obtained as B1a−B2b, in which the color rendering is corrected.

The subtractor 79 subtracts the G2a image signal and the G2c image signal from the G1b image signal output by the green pixels in the second violet, blue, green and red light emission in the first emission mode, the G2a image signal being output by the green pixels in the violet and blue light emission in the second emission mode, the G2c image signal being output by the green pixels in the red light emission. The G2a image signal is an image signal obtained by the green pixels receiving partial returned light of the violet and blue light V and B. Thus, the subtraction of the image signals (G1b−G2a−G2c) obtains the G1b corrected image signal, with which the color rendering is corrected.

The subtractor 79 subtracts the R2b image signal output by the red pixels in the green light emission in the second emission mode from the R1a image signal output by the red pixels in the first violet, blue, green and red light emission in the first emission mode. Thus, the R1a corrected image signal is obtained as R1a−R2b, in which the color rendering is corrected.

Consequently, it is possible to obtain a relatively long available period for imaging at a required intensity, to increase brightness in the high quality image, because time of startup of the LEDs 20a-20d is shortened.

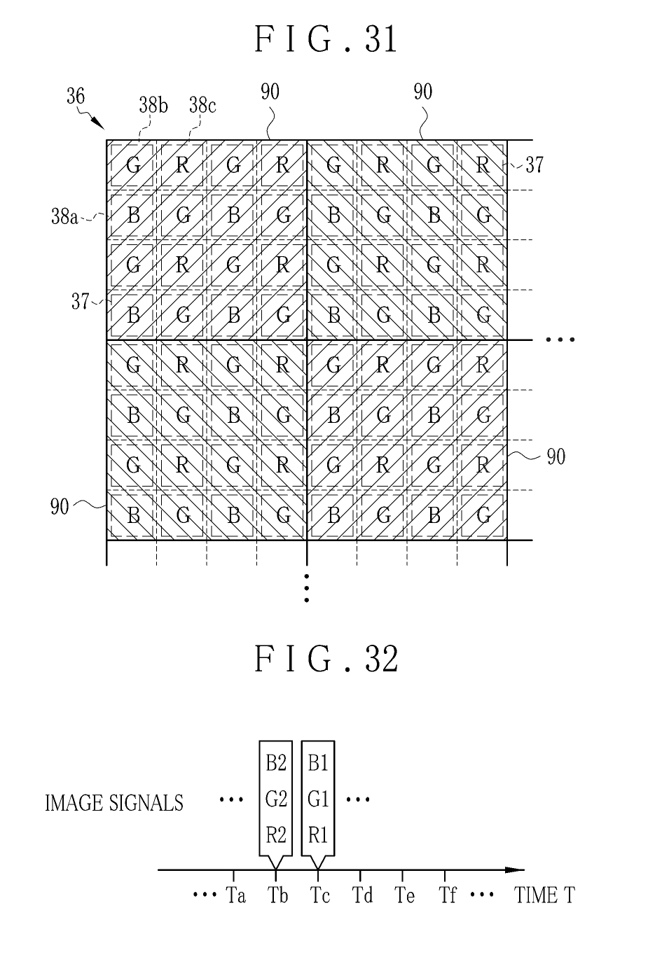

In the above embodiments, the subtractor 79 performs the subtraction for each of the pixels. However, the subtractor 79 can perform subtraction for respective areas in each of which plural pixels are contained. In FIG. 31, the subtractor 79 performs the subtraction respectively for an area 90 (sub-area) containing 4×4 pixels among the pixels 37 arranged two-dimensionally on an imaging surface of the color image sensor 36. The subtractor 79 obtains an average of image signals obtained from 16 pixels 37. The operation of obtaining the average is performed for each of all of the areas 90. It is possible to perform the processing in the processing apparatus 16 at a high speed, because time required until completing the subtraction for all of the pixels 37 can be shorter than that required for the subtraction for the respective pixels.

Also, the area 90 (one area or more) may be defined to contain only the pixels 37 disposed near to the center among all of the pixels 37 arranged on the imaging surface of the color image sensor 36. In case a doctor discovers a region of a candidate of a lesion in a high quality image, he or she may manipulate the endoscope 12 to set the region of the candidate of the lesion near to the image center in the high quality image. Thus, the subtraction is performed only in relation to the area 90 containing the pixels 37 near to the image center in the high quality image, so that speed of processing of the processing apparatus 16 can be increased.

Also, it is possible for the subtractor 79 to perform the subtraction only for the pixels 37 of occurrence of color mixture. To this end, a pixel detector is provided, and operates for detecting a specific pixel among the pixels 37 included in the blue pixels and of which a level of the B2 image signal output in the second emission mode is equal to or more than a predetermined threshold, to recognize the specific pixel with the color mixture. The subtractor 79 performs the subtraction only for the specific pixel with the color mixture among the pixels 37. Thus, it is possible to increase in a processing speed of the processing apparatus 16.

In the above embodiment, the first imaging time point (Tc) of imaging the object of interest illuminated in the first emission mode is set by the imaging controller 40 earlier than the second imaging time point (Td) of imaging the object of interest illuminated in the second emission mode. However, the first imaging time point can be set later than the second imaging time point. In FIG. 32, the time Tc included in the times Ta-Tf is set as a first imaging time point of imaging the object of interest illuminated in the first emission mode. The time Tb is set as a second imaging time point of imaging the object of interest illuminated in the second emission mode.

Specifically, the subtractor 79 subtracts the B2 image signal output by the blue pixels from the B1 image signal output by the blue pixels, the B1 image signal being one of the B1, G1 and R1 image signals output upon imaging at the first time point later than the second time point, the B2 image signal being one of the B2, G2 and R2 image signals output upon imaging at the second time point.

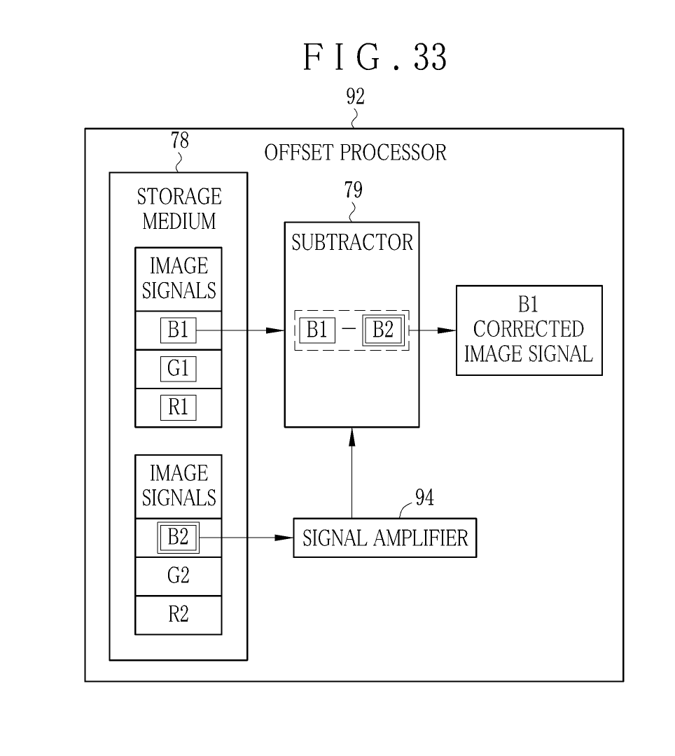

Furthermore, an offset processor 92 in FIG. 33 can be provided in place of the offset processor 71 of the above embodiments. The offset processor 92 includes a signal amplifier 94 in addition to the storage medium 78 and the subtractor 79 in the offset processor 71.

The signal amplifier 94 amplifies the image signal output by the particular pixels among the image signals output in the second emission mode. In the first embodiment, the B1, G1 and R1 image signals are output in the violet, blue, green and red light emission (VBGR) in the first emission mode. The B2, G2 and R2 image signals are output in the green light emission in the second emission mode. Then the signal amplifier 94 amplifies the B2 image signal output by the blue pixels as particular pixels among the image signals among the B2, G2 and R2 image signals. See FIG. 33.

Specifically, the signal amplifier 94 obtains a time ratio Tx/Ty of the emission time Tx in the first emission mode to the emission time Ty in the second emission mode, and multiplies the B2 image signal by the time ratio Tx/Ty. The emission times Tx and Ty of the first and second emission modes satisfy the condition of Tx>Ty. Thus, the time ratio Tx/Ty is larger than 1. In the embodiment, the emission time Ty is ¼ as long as the emission time Tx. Thus, the time ratio Tx/Ty is 4. Then the subtraction for the B1 image signal obtained in the first emission mode is performed by use of the amplified B2 image signal.

Consequently, occurrence of poor quality in the color rendering can be prevented reliably, because the subtraction in the subtractor 79 can be performed accurately by amplifying the image signal output by the second emission mode according to the ratio in the emission time between the first and second emission modes even with a shorter value of the emission time in the second emission mode than in the first emission mode and even with a smaller exposure amount of light emitted in the second emission mode.

The signal amplifier 94 can perform the amplification of the image signals for each of the area containing plural pixels, for example, 4×4 pixels. The image signals obtained from the plural pixels in the area are averaged, and then the averaged image signal is amplified. This is effective in reducing occurrence of noise in comparison with a structure of amplifying the image signals for each of the pixels. The area for amplifying the image signals can be set in association with the area 90 illustrated in FIG. 31.

Furthermore, it is possible to control the LEDs 20a-20d in the light source controller 22 for increasing the intensity of light emitted in the second emission mode instead of amplifying the image signal in the signal amplifier 94. To this end, the intensity of light in the second emission mode is increased by a value of a decrease in the emission time Ty in the second emission mode relative to the emission time Tx in the first emission mode. For example, let the emission time Ty be ¼ as long as the emission time Tx. Then the intensity of light in the second emission mode is set four times as high as the intensity of light in the first emission mode.

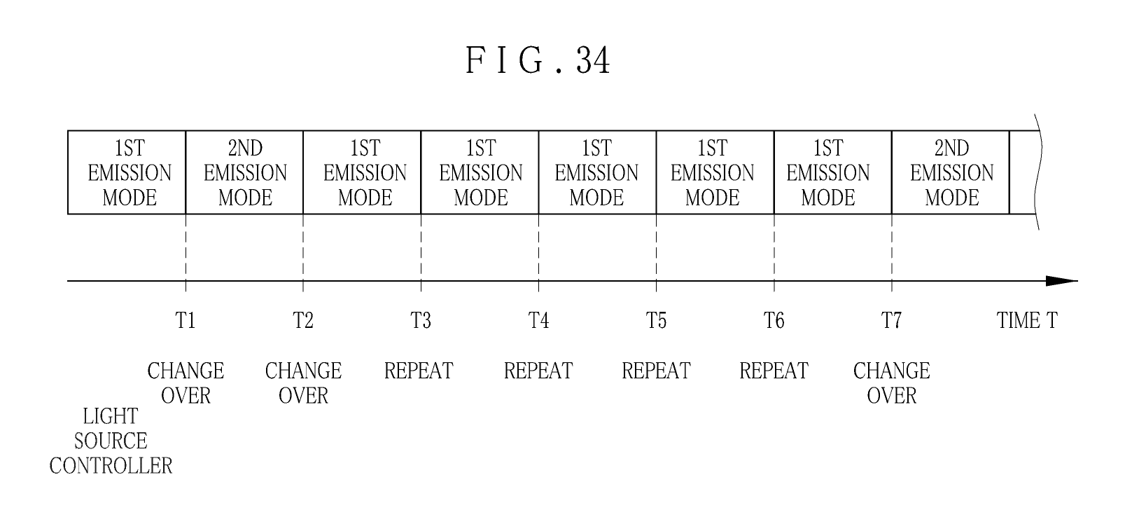

In the above embodiments, the light source controller 22 changes over the first and second emission modes. However, it is additionally possible to repeat the first emission mode according to a selectable control. In FIG. 34, the light source controller 22 periodically performs first and second controls, the first control being used for changing over the first and second emission modes (indicated as CHANGE OVER in FIG. 34), the second control being used for repeating the first emission mode (indicated as REPEAT in FIG. 34). The first control of changeover is used upon stop of movement of the endoscope 12 and upon start of its movement. The second control of the repetition is used during a period from the stop of the movement of the endoscope 12 until the start of its movement.

In FIG. 34, let the endoscope 12 be stopped from moving at time T1. Let the endoscope 12 start movement at time T7. At the time T1, control for changing over from the first emission mode to the second emission mode is performed. At time T2, control for changing over from the second emission mode to the first emission mode is performed. At times T3-T6, operation in the first emission mode is repeated. At the time T7, control for changing over from the first emission mode to the second emission mode is performed.

Assuming that there is color mixture at the pixels upon the stop of the endoscope 12, occurrence of similar color mixture may remain at the pixels in the period until the start of the movement of the endoscope 12. Thus, the subtraction is successively performed by use of the B2, G2 and R2 image signals output in the second emission mode upon the stop of the endoscope 12 in the period from the stop of the endoscope 12 until the start of the endoscope 12 at each time that the B1, G1 and R1 image signals are output in the first emission mode of the repetition. Assuming that the endoscope 12 is stopped, it is likely that a doctor is carefully observing the object of interest. The structure of the embodiment makes it possible to provide a moving image of a high frame rate to the doctor.

In the above embodiment, the high quality image generator 60 generates the high quality image according to the B1 corrected image signal and the G1 and R1 image signals. In addition to the high quality image, it is possible to generate a green light image according to the G2 image signal output by the green pixels, among the B2, G2 and R2 image signals output in the green light emission in the second emission mode. In the green light emission, the green light G of the wide range of a wavelength of 500-600 nm is used, so that the object of interest is illuminated more brightly than the use of the violet, blue or red light V, B or R. In general, the green light image with a wavelength component of the green light G is an image with a relatively high brightness. For example, the green light image can be arranged and displayed with the high quality image in the monitor display panel 18. Furthermore, it is possible to use a changeable display capable of changeover between the high quality image and the green light image.

Also, the high quality image generator 60 can produce an image according to the G2 image signal, a first image signal from the blue pixels, and a second image signal from the red pixels, the G2 image signal being output by the green pixels among signals output in the green light emission, the first and second image signals being among image signals output before or after the imaging in the green light emission. For example, let imaging be performed in the violet, blue, green and red light emission in the first emission mode before the green light emission in the second emission mode. An image is produced according to the G2, B1 and R1 image signals, the G2 image signal being output in the green light emission in the second emission mode, the B1 and R1 image signals being output in the violet, blue, green and red light emission in the first emission mode. As the image contains a component of a wavelength of visible light, the image corresponds to the normal image produced by the normal image generator 58. It is possible to display and arrange the normal image beside the high quality image on the monitor display panel 18. Also, display of the normal image and the high quality image can be changed over with one another.

Also, a positioning device can be provided in the offset processor for positioning between image signals for use in the subtraction. The positioning device calculates a position shift between image signals output by pixels of an equal color among the image signals output in the first emission mode and the image signals output in the second emission mode. For example, the violet, blue, green and red light emission (VBGR) is performed in the first emission mode in the first embodiment. The green light emission is performed in the second emission mode. A position shift between the B1 and B2 image signals is calculated, among the B1, G1 and R1 image signals output in the violet, blue, green and red light emission and among the B2, G2 and R2 image signals output in the green light emission. Also, the positioning device performs positioning between the B1 and B2 image signals by use of the obtained position shift. The positioning is performed all of the pixels. The subtractor 79 performs the subtraction by use of the B1 and B2 image signals after the positioning. It is therefore possible reliably to prevent occurrence of poor quality of the color rendering even upon occurrence of the position shift between the image signal output in the first emission mode and the image signal output in the second emission mode.

Furthermore, it is possible suitably to change colors of light for emission in the first emission mode, and colors of light for emission in the second emission mode.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An endoscope system comprising:
a light source controller for controlling changeover between first and second emission modes, said first emission mode being for emitting light of at least two colors among plural colors of light emitted discretely by a light source, said second emission mode being for emitting partial light included in said light emitted in said first emission mode;
a color image sensor having pixels of said plural colors, said pixels including particular pixels sensitive to a light component included in said light emitted in said first emission mode but different from said partial light emitted in said second emission mode, said particular pixels being also sensitive to said partial light emitted in said second emission mode;
an imaging controller for controlling said color image sensor to image an object illuminated in said first emission mode to output first image signals, and controlling said color image sensor to image said object illuminated in said second emission mode to output second image signals;
a subtractor for performing subtraction of an image signal output by said particular pixels among said second image signals from an image signal output by said particular pixels among said first image signals;
an image processor for generating a specific image according to said first image signals after said subtraction.

2. An endoscope system as defined in claim 1, wherein said light source controller sets emission time of emitting said light in said second emission mode shorter than emission time of emitting said light in said first emission mode.

3. An endoscope system as defined in claim 1, wherein said subtractor performs said subtraction for each of said pixels.

4. An endoscope system as defined in claim 1, wherein said subtractor performs said subtraction for a respective area containing plural pixels among said pixels.

5. An endoscope system as defined in claim 1, wherein said imaging controller performs imaging of said object illuminated in said first emission mode at a first imaging time point, and performs imaging of said object illuminated in said second emission mode at a second imaging time point different from said first imaging time point;
said subtractor performs said subtraction so that said image signal output by said particular pixels among said second image signals output by imaging at said second imaging time point is subtracted from said image signal output by said particular pixels among said first image signals output by imaging at said first imaging time point being earlier than said second imaging time point.

6. An endoscope system as defined in claim 1, wherein said imaging controller performs imaging of said object illuminated in said first emission mode at a first imaging time point, and performs imaging of said object illuminated in said second emission mode at a second imaging time point different from said first imaging time point;
said subtractor performs said subtraction so that said image signal output by said particular pixels among said second image signals output by imaging at said second imaging time point is subtracted from said image signal output by said particular pixels among said first image signals output by imaging at said first imaging time point being later than said second imaging time point.

7. An endoscope system as defined in claim 1, further comprising a signal amplifier for amplifying said image signal output by said particular pixels among said second image signals.

8. An endoscope system as defined in claim 7, wherein said signal amplifier averages an image signal output from an area containing plural pixels among said pixels, to perform said amplification for respectively said area.

9. An endoscope system as defined in claim 1, further comprising a storage medium for storing said second image signals;
wherein said subtractor performs said subtraction by use of said image signal output by said particular pixels among said second image signals stored in said storage medium.

10. An endoscope system as defined in claim 1, wherein said light source controller further performs a control of repeating said first emission mode in addition to a control of changing over said first and second emission modes;
said light source controller periodically performs said control of changing over and said control of repeating said first emission mode.

11. An endoscope system as defined in claim 1, wherein said light source includes a violet light source device for emitting violet light, a blue light source device for emitting blue light, a green light source device for emitting green light, and a red light source device for emitting red light;
said particular pixels are at least one of blue pixels sensitive to said violet light and said blue light, red pixels sensitive to said red light, and green pixels sensitive to said green light.

12. An endoscope system as defined in claim 11, wherein said light source controller in said first emission mode performs violet, blue, green and red light emission to emit said violet light, said blue light, said green light and said red light by controlling said violet, blue, green and red light source devices;
said subtractor performs said subtraction so that said image signal output by said particular pixels among said second image signals output in said second emission mode is subtracted from said image signal output by said particular pixels among said first image signals output in said violet, blue, green and red light emission.

13. An endoscope system as defined in claim 11, wherein said light source controller in said second emission mode performs violet, blue and red light emission to emit said violet light, said blue light and said red light by controlling said violet, blue and red light source devices, and performs green light emission to emit said green light by controlling said green light source device;
said imaging controller in said second emission mode performs imaging of said object illuminated by said violet, blue and red light emission and imaging of said object illuminated by said green light emission;
said subtractor performs said subtraction so that an image signal output by said blue pixels constituting said particular pixels among said second image signals output in said green light emission is subtracted from an image signal output by said blue pixels constituting said particular pixels among said first image signals output in said violet, blue, green and red light emission;
said subtractor performs said subtraction so that an image signal output by said green pixels constituting said particular pixels among said second image signals output in said violet, blue and red light emission is subtracted from an image signal output by said green pixels constituting said particular pixels among said first image signals output in said violet, blue, green and red light emission;
said subtractor performs said subtraction so that an image signal output by said red pixels constituting said particular pixels among said second image signals output in said green light emission is subtracted from an image signal output by said red pixels constituting said particular pixels among said first image signals output in said violet, blue, green and red light emission.

14. An endoscope system as defined in claim 11, wherein said light source controller in said first emission mode performs blue and red light emission to emit said blue light and said red light by controlling said blue and red light source devices, and performs violet and green light emission to emit said violet light and said green light by controlling said violet and green light source devices, and said light source controller in said second emission mode performs green light emission to emit said green light by controlling said green light source device;
said imaging controller in said first emission mode performs imaging of said object illuminated by said blue and red light emission and imaging of said object illuminated by said violet and green light emission, and said imaging controller in said second emission mode performs imaging of said object illuminated by said green light emission;
said subtractor performs said subtraction so that an image signal output by said blue pixels constituting said particular pixels among said second image signals output in said green light emission is subtracted from an image signal output by said blue pixels constituting said particular pixels among said first image signals output in said violet and green light emission.

15. An endoscope system as defined in claim 11, wherein said light source controller in said first emission mode performs violet, blue and red light emission to emit said violet light, said blue light and said red light by controlling said violet, blue and red light source devices, and performs green light emission to emit said green light by controlling said green light source device, and said light source controller in said second emission mode performs red light emission to emit said red light by controlling said red light source device;
said imaging controller in said first emission mode performs imaging of said object illuminated by said violet, blue and red light emission and imaging of said object illuminated by said green light emission, and said imaging controller in said second emission mode performs imaging of said object illuminated by said red light emission;
said subtractor performs said subtraction so that an image signal output by said blue pixels constituting said particular pixels among said second image signals output in said red light emission is subtracted from an image signal output by said blue pixels constituting said particular pixels among said first image signals output in said violet, blue and red light emission.

16. An endoscope system as defined in claim 11, wherein said light source controller in said first emission mode performs violet, blue and red light emission to emit said violet light, said blue light and said red light by controlling said violet, blue and red light source devices, and performs green light emission to emit said green light by controlling said green light source device, and said light source controller in said second emission mode performs violet and blue light emission to emit said violet light and said blue light by controlling said violet and blue light source devices;
said imaging controller in said first emission mode performs imaging of said object illuminated by said violet, blue and red light emission and imaging of said object illuminated by said green light emission, and said imaging controller in said second emission mode performs imaging of said object illuminated by said violet and blue light emission;
said subtractor performs said subtraction so that an image signal output by said red pixels constituting said particular pixels among said second image signals output in said violet and blue light emission is subtracted from an image signal output by said red pixels constituting said particular pixels among said first image signals output in said violet, blue and red light emission.

17. An endoscope system as defined in claim 11, wherein said light source controller in said second emission mode performs green light emission to emit said green light by controlling said green light source device;
said imaging controller performs imaging of said object illuminated by said green light emission;
said image processor generates a green light image having a wavelength component of said green light according to an image signal output by said green pixels constituting said particular pixels among said second image signals output in said green light emission.

18. An endoscope system as defined in claim 11, wherein said light source controller in said second emission mode performs green light emission to emit said green light by controlling said green light source device;
said imaging controller performs imaging of said object illuminated by said green light emission;
said image processor generates a normal image having a wavelength component of visible light according to an image signal output by said green pixels among said second image signals output in said green light emission, and a blue image signal output by said blue pixels, and an red image signal output by said red pixels, said blue and red image signals being among image signals output by imaging before or after imaging in said green light emission.

19. A method of operating an endoscope system, comprising steps of:
controlling changeover in a light source controller between first and second emission modes, said first emission mode being for emitting light of at least two colors among plural colors of light emitted discretely by a light source, said second emission mode being for emitting partial light included in said light emitted in said first emission mode;
using an imaging controller for controlling a color image sensor to image an object illuminated in said first emission mode to output first image signals, and for controlling said color image sensor to image said object illuminated in said second emission mode to output second image signals, wherein said color image sensor has pixels of said plural colors, said pixels including particular pixels sensitive to a light component included in said light emitted in said first emission mode but different from said partial light emitted in said second emission mode, said particular pixels being also sensitive to said partial light emitted in said second emission mode;
performing subtraction of an image signal output by said particular pixels among said second image signals from an image signal output by said particular pixels among said first image signals in a subtractor;
generating a specific image according to said first image signals after said subtraction in an image processor.
